(19) United States
(12) Patent Application Publication
(10) Pub. No.: US 2026/0067908 A1
(43) Pub. Date: Mar. 5, 2026

(54) SIDELINK FEEDBACK INFORMATION TRANSMISSION METHOD AND APPARATUS, TERMINAL, CHIP, AND STORAGE MEDIUM

(71) Applicant: GUANGDONG OPPO MOBILE TELECOMMUNICATIONS CORP., LTD., Dongguan (CN)

(72) Inventors: Teng MA, Dongguan (CN); Zhenshan ZHAO, Dongguan (CN); Shichang ZHANG, Dongguan (CN)

(21) Appl. No.: 19/386,546

(22) Filed: Nov. 12, 2025

Related U.S. Application Data
(63) Continuation of application No. PCT/CN2023/112187, filed on Aug. 10, 2023.

(51) Int. Cl. H04W 72/25; H04L 1/1829

(52) U.S. Cl. CPC H04W 72/25; H04L 1/1864

(57) ABSTRACT

A method for sidelink feedback information transmission, applied to a first terminal, includes that: the first terminal sends a first transport block to a second terminal on a plurality of first physical sidelink shared channel (PSSCH) resources; and the first terminal receives first feedback information from the second terminal on a first physical sidelink feedback channel (PSFCH) resource, where the first feedback information is feedback for reception of the first transport block by the second terminal on the plurality of first PSSCH resources. There is also provided a first terminal and a second terminal.

### CROSS-REFERENCE TO RELATED APPLICATION

This application is a continuation of International Patent Application No. PCT/CN2023/112187 filed on Aug. 10, 2023, the disclosure of which is incorporated herein by reference in its entirety.

### BACKGROUND

In the existing Sidelink (SL) technology, each Physical Sidelink Shared Channel (PSSCH) corresponds to a feedback resource on a Physical Sidelink Feedback Channel (PSFCH). However, if each PSSCH corresponds to a PSFCH feedback resource, then the terminal needs to frequently perform transmission/reception of PSFCHs, which leads to large power consumption for certain terminals with weak capabilities (such as reduced capability equipment (RedCap UE)).

### SUMMARY

Embodiments of the present application relate to the technical field of communications, and in particular to a method and an apparatus for sidelink feedback information transmission, a terminal, a chip, and a storage medium.

Embodiments of the present application provide a method for sidelink feedback information transmission, a first terminal, and a second terminal.

According to a first aspect, an embodiment of the present disclosure provides a method for sidelink feedback information transmission, which is applied to a first terminal, and the method includes the following operations. A first transport block is sent to a second terminal on a plurality of first physical sidelink shared channel (PSSCH) resources. First feedback information is received from the second terminal on a first physical sidelink feedback channel (PSFCH) resource, the first feedback information being feedback for reception of the first transport block by the second terminal on the plurality of first PSSCH resources.

According to a second aspect, an embodiment of the present application provides a first terminal, including a processor, and a memory for storing a computer program, wherein the processor is configured to invoke and execute the computer program stored in the memory to cause the first terminal to perform the method as described in the first aspect.

According to a third aspect, an embodiment of the present application provides a second terminal, including a processor, and a memory for storing a computer program. The processor is configured to invoke and execute the computer program stored in the memory to cause the second terminal to: receive a first transport block from a first terminal on a plurality of first physical sidelink shared channel (PSSCH) resources; and send first feedback information to the first terminal on a first physical sidelink feedback channel (PSFCH) resource, the first feedback information being feedback for reception of the first transport block by the second terminal on the plurality of first PSSCH resources.

### BRIEF DESCRIPTION OF THE DRAWINGS

The accompanying drawings illustrated herein are used to provide further understanding of the present disclosure, and constitute a part of the present disclosure. Illustrative embodiments of the present disclosure and their descriptions are used to explain the disclosure instead of constituting improper limitation to the present disclosure.

FIG. 1 is a schematic diagram of sidelink communication within network coverage provided by an embodiment of the present disclosure.

FIG. 2 is a schematic diagram of sidelink communication partially within network coverage provided by an embodiment of the disclosure.

FIG. 3 is a schematic diagram of sidelink communication outside network coverage provided by an embodiment of the present disclosure.

FIG. 4 is a schematic diagram of sidelink communication with a central control node provided by an embodiment of the present disclosure.

FIG. 5 is a schematic diagram of a unicast transmission mode provided by an embodiment of the present disclosure.

FIG. 6 is a schematic diagram of a multicast transmission mode provided by an embodiment of the disclosure.

FIG. 7 is a schematic diagram of a broadcast transmission mode provided by an embodiment of the present disclosure.

FIG. 8A is a schematic diagram of a slot structure in NR-V2X provided by an embodiment of the present disclosure.

FIG. 8B is another schematic diagram of a slot structure in NR-V2X provided by an embodiment of the present disclosure.

FIG. 9 is a schematic diagram illustrating changes in available OFDM symbols within slots for different transmissions of one PSSCH provided by an embodiment of the present disclosure.

FIG. 10 is a schematic diagram of a mapping manner for second-stage SCI provided by an embodiment of the present disclosure.

FIG. 11 is a schematic diagram of time and frequency domain positions of PSCCH DMRS provided by an embodiment of the present disclosure.

FIG. 12 is a schematic diagram of time domain positions of four DMRS symbols when PSSCH has 13 symbols provided by an embodiment of the present disclosure.

FIG. 13 is a schematic diagram of a single-symbol DMRS frequency domain Type 1 provided by an embodiment of the present disclosure.

FIG. 14 is a schematic diagram of time and frequency domain positions of SL CSI-RS provided by an embodiment of the present disclosure.

FIG. 15 is a schematic diagram of an example of channel occupancy time and channel occupancy provided by an embodiment of the present disclosure.

FIG. 16 is a schematic flowchart of a method for sidelink feedback information transmission provided by an embodiment of the present disclosure.

FIG. 17A is a schematic diagram of a first example of sidelink feedback information transmission provided by an embodiment of the present disclosure.

FIG. 17B is a schematic diagram of a first example of sidelink feedback information transmission provided by an embodiment of the present disclosure.

FIG. 17C is a schematic diagram of a first example of sidelink feedback information transmission provided by an embodiment of the present disclosure.

FIG. 18A is a schematic diagram of a second example of sidelink feedback information transmission provided by an embodiment of the present disclosure.

FIG. 18B is a schematic diagram of a second example of sidelink feedback information transmission provided by an embodiment of the present disclosure.

FIG. 19 is a first schematic diagram of collaborative operation of DRX and SL feedback functions provided by an embodiment of the present disclosure.

FIG. 20 is a second schematic diagram of collaborative operation of DRX and SL feedback functions provided by an embodiment of the present disclosure.

FIG. 21 is a schematic diagram of collaborative operation of DRX function and COT duration provided by an embodiment of the present disclosure.

FIG. 22 is a first schematic diagram of an apparatus for sidelink feedback information transmission provided by an embodiment of the present disclosure.

FIG. 23 is a second schematic diagram of an apparatus for sidelink feedback information transmission provided by an embodiment of the present disclosure.

FIG. 24 is a schematic structure diagram of a communication device provided by an embodiment of the present disclosure.

FIG. 25 is a schematic structure diagram of a chip provided by an embodiment of the present disclosure.

### DETAILED DESCRIPTION

The technical solution of the embodiments of the present disclosure will be described below in conjunction with the drawings in the embodiments of the present disclosure. It is apparent that the described embodiments are part of the embodiments of the present disclosure, but not all of them. Based on the embodiments in the present disclosure, all other embodiments obtained by those of ordinary skill in the art without creative work shall fall within the scope of protection of the present disclosure.

The technical solutions of the embodiments of the present disclosure may be applied to various sidelink communication systems. In order to facilitate understanding of the technical solutions of the embodiments of the present disclosure, related technologies of the embodiments of the present disclosure are described as follows. The following related technologies may be arbitrarily combined with the technical solution of the embodiments of the present disclosure as optional solutions, all of which belong to the protection scope of the embodiments of the present disclosure.

### 1. Sidelink Communications in Different Network Coverage Environments

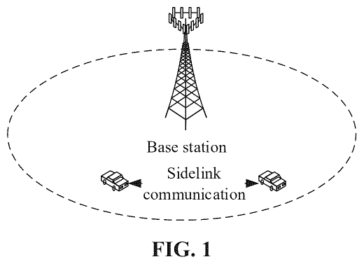

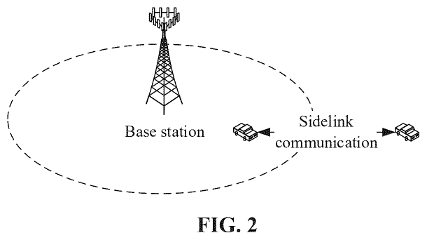

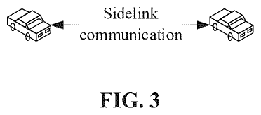

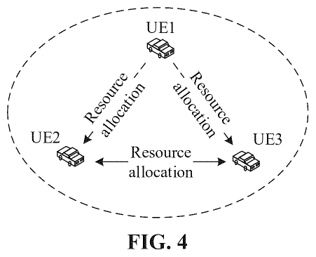

In sidelink communications, according to situations of network coverage where communication terminals is located, the sidelink communications may be divided into sidelink communication within network coverage as illustrated in FIG. 1, sidelink communication partially within network coverage as illustrated in FIG. 2, sidelink communication outside network coverage as illustrated in FIG. 3, and sidelink communication with a central control node as illustrated in FIG. 4.

As illustrated in FIG. 1, in the sidelink communication within the network coverage, all terminals performing sidelink communication are within the coverage of the same base station, so that all of these terminals may perform sidelink communication based on the same sidelink configuration by receiving a configured signaling from the base station.

As illustrated in FIG. 2, in the case of sidelink communication partially within network coverage, some terminals performing sidelink communication are located within the coverage range of the base station, and these terminals can receive configuration signaling from the base station, and perform sidelink communication according to the configuration of the base station. However, terminals outside the network coverage cannot receive the configuration signaling from the base station. In this case, the terminals outside the network coverage determine sidelink configuration according to pre-configuration information and information carried in the sidelink broadcast channel (PSBCH) sent by the terminals outside the network coverage, so as to perform sidelink communication.

As illustrated in FIG. 3, for sidelink communication outside the network coverage, all terminals performing sidelink communication are located outside the network coverage, and all of the terminals determine sidelink configuration based on pre-configuration information and perform sidelink communication.

As illustrated in FIG. 4, for the sidelink communication with a central control node, multiple terminals form a communication group, and there is a central control node (such as UE1 in FIG. 4) in the communication group. The central control node may also be called a Cluster Header (CH). The central control node has, but is not limited to, at least one of the following functions: responsible for establishment of the communication group; joining and leaving of group members; performing resource coordination, allocating sidelink transmission resources for other terminals and receiving sidelink feedback information from other terminals; performing resource coordination with other communication groups.

### 2. Device to Device (D2D)/Vehicle to Everything (V2X)

D2D communication is a sidelink transmission technology based on D2D, which is different from a traditional cellular system where communication data is received or sent through a base station, and thus the D2D communication has higher spectrum efficiency and lower transmission delay. V2X systems adopt a direct terminal-to-terminal communication approach, and the 3rd Generation Partnership Project (3GPP) has defined two transmission modes: mode 1 and mode 2.

In mode 1, transmission resources for terminals are allocated by a base station, and the terminals send data on a sidelink according to the resources allocated by the base station. The base station may allocate resources for single transmission to the terminals, or may also allocate resources for semi-persistent transmission to the terminals. As illustrated in FIG. 1, terminals are located within the coverage of a network, and the network allocates transmission resources for sidelink transmission to the terminals.

In mode 2, terminals select resources from a resource pool to perform data transmission. As illustrated in FIG. 3, e terminals are located outside the coverage area of a cell, and the terminals select transmission resources autonomously in a pre-configured resource pool for sidelink transmission. Or, as illustrated in FIG. 1, the terminals select the transmission resources autonomously in a resource pool configured by the network for sidelink transmission

### 3. New Radio-Vehicle to Everything (NR-V2X)

In NR-V2X, automatic driving is to be supported. Therefore, higher requirements are put forward for data interaction between vehicles, such as higher throughput, lower latency, higher reliability, larger coverage and more flexible resource allocation.

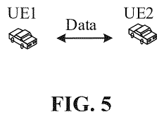

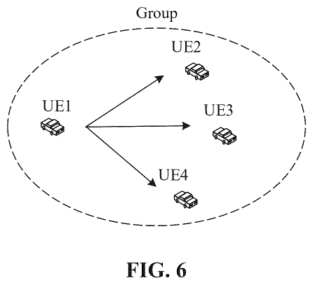

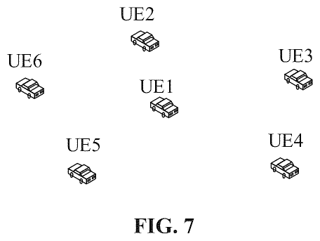

In LTE-V2X, a broadcast transmission mode is supported, and thus unicast and multicast transmission modes are introduced in NR-V2X. For unicast transmission, there is only one terminal as a receiver terminal, and as illustrated in FIG. 5, unicast transmission is performed between UE1 and UE2. For multicast transmission, the receiver terminal refers to all terminals in a communication group or all terminals within a certain transmission distance. As illustrated in FIG. 6, UE1, UE2, UE3 and UE4 form a communication group, in which UE1 sends data, and other terminal devices in the group are receiver terminals. In the broadcast transmission mode, the receiver terminal is any terminal around a sender terminal, and as illustrated in FIG. 7, UE1 is the sender terminal, and its surrounding terminals UE2, UE3, UE4, UE5 and UE6 are all receiver terminals.

### 4. Frame Structure in NR-V2X System

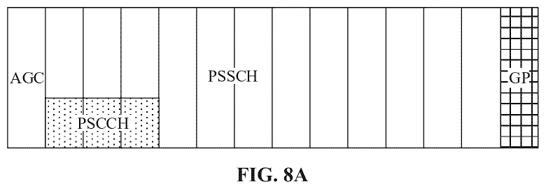

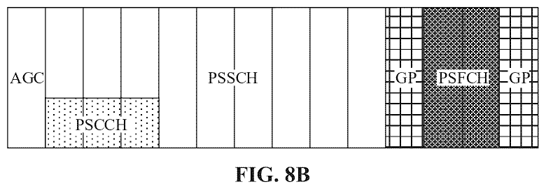

Slot structures of NR-V2X are illustrated in FIG. 8A and FIG. 8B.

FIG. 8A illustrates a schematic diagram of a slot structure in which a Physical Sidelink Feedback Channel (PSFCH) is not included in the slot, and FIG. 8B illustrates a schematic structure diagram of a slot structure in which the PSFCH is included in the slot.

In NR-V2X, a Physical Sidelink Control Channel (PSCCH) occupies 2 or 3 Orthogonal frequency-division multiplexing (OFDM) symbols in the time domain starting from a second sidelink symbol of the slot, and may occupy {10, 12 15, 20, 25} physical resource blocks (PRBs) in the frequency domain. In order to reduce the complexity of blind detection of PSCCH by UE, only one number of PSCCH symbol and one number of PRB may be configured in a resource pool. In addition, because a sub-channel is the minimum granularity in resource allocation of Physical Sidelink Shared Channel (PSSCH) in the NR-V2X, the number of PRBs occupied by PSCCH must be less than or equal to the number of PRBs contained in a sub-channel within the resource pool, so as to avoid additional restrictions on PSSCH resource selection or allocation. PSSCH also starts from the second sidelink symbol of the slot in time domain, the last time domain symbol in the slot is a Guard Period (GP) symbol, and remaining symbols is used for PSSCH mapping. The first sidelink symbol in the slot is repetition of the second sidelink symbol, and is typically used by the receiver terminal as an Automatic Gain Control (AGC) symbol, data on which is not used for data demodulation typically. PSSCH occupies the number of K sub-channels in the frequency domain, and each sub-channel includes the number of N consecutive PRBs.

When a PSFCH channel is included in a slot, the second-to-last symbol and the third-to-last symbol in the slot are used for PSFCH transmission, and a time domain symbol preceding the PSFCH channel is used as a GP symbol, as illustrated in FIG. 8B

### 5. Sidelink PSSCH

In NR-V2X, PSSCH is used to carry second-stage Sidelink Control Information (SCI) (i.e., SCI 2-A or SCI 2-B) and data information. The second-stage SCI adopts a Polar coding manner and fixedly adopts Quadrature Phase Shift Keying (QPSK) modulation. A data portion of PSSCH uses Low Density Parity Check (LDPC), supporting a maximum modulation order of 256QAM.

In NR-V2X, PSSCH supports at most transmission of two streams, and uses a unit pre-coding matrix to map data on two layers into two antenna ports. Within a single PSSCH, only one Transport Block (TB) may be sent at most. However, unlike the transmission manner of the data portion of the PSSCH, when the PSSCH adopts a dual-stream transmission manner, modulation symbols sent by the second-stage SCI on the two streams are identical. Such a design can ensure the reception performance of the second-stage SCI in highly correlated channels.

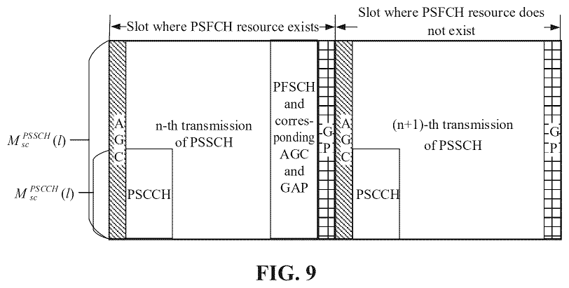

Since the maximum number of retransmissions of one PSSCH in NR-V2X is 32, if PSFCH resources exist in a resource pool and a configured period for the PSFCH resources is 2 or 4, then available OFDM symbols in slots for different transmissions of one PSSCH may change, as illustrated in FIG. 9. If

$${N}_{symbol}^{PSSCH}$$

is calculated according to the true number of OFDM symbols in a slot,

$${Q}_{SCI 2}^{′}$$

may vary due to the difference in the number of symbols available for PSSCH transmission in a slot, whereas the change

$${Q}_{SCI 2}^{′}$$

may result in a change in the size of a TB carried by the PSSCH. In order to ensure that a Transport Block Size (TBS) remains unchanged during multiple PSSCH transmissions, when calculating

$${N}_{symbol}^{PSSCH} ,$$

the true number or PSFCH symbols is not used. In addition, when calculating

$${M}_{sc}^{SCI 2} ( l ) ,$$

the number of Resource Elements (REs) occupied by a PSSCH Demodulation Reference Signal (DMRS) and the number of REs occupied by a Phase-Tracking Reference Signals (PT-RS) that may change in the retransmission process are also not taken into account.

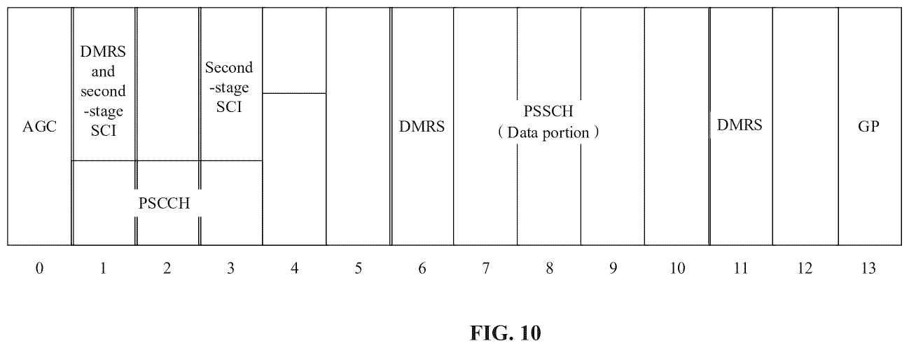

A code rate of the second-stage SCI may be adjusted dynamically within a certain range, and a specific code rate used is indicated by the first-stage SCI, so even after the code rate is changed, the receiving end does not need to perform blind detection on the second-stage SCI. The modulation symbols of the second-stage SCI are mapped from a symbol in which a first PSSCH DMRS is located, following a frequency-domain-first and then time-domain mapping approach, and the second-stage SCI is mapped to a RE not occupied by the DMRS on the OFDM symbols in which the DMRS is located, as illustrated in FIG. 10.

Data portion of the PSSCH within a resource pool may employ a plurality of different Modulation and Coding Scheme (MCS) tables, including a conventional 64QAM MCS table, a 256QAM MCS table, and a 64QAM MCS table with low spectral efficiency. A MCS table specifically employed in one transmission is indicated by a “MCS Table Indication” field in the first-stage SCI. In order to control a Peak to Average Power Ratio (PAPR), the PSSCH must be sent using contiguous Physical Resource Blocks (PRBs). Since a sub-channel is the minimum frequency domain resource granularity for the PSSCH, it is required that the PSSCH must occupy continuous sub-channels.

### 6. Sidelink Transport Block Size

The PSSCH follows a TBS determination mechanism of a Physical Downlink Shared Channel (PDSCH) and a Physical Uplink Shared Channel (PUSCH) in New Radio (NR). That is, TBS is determined according to a reference value of the number of REs used for PSSCH in the slot where the PSSCH is located, so that an actual code rate is as close as possible to a target code rate. The purpose of using the reference value of the number of REs instead of the actual number of REs herein is to ensure that the number of REs used to determine the TBS in the PSSCH retransmission process remains unchanged, so that the determined TBSs have the same size. To achieve this, a reference value N_{RE} for the number of REs occupied by the PSSCH during a TBS determination process is determined according to Equation (1):

$${N}_{RE} = {N}_{RE}^{′} \cdot {n}_{PRB} - {N}_{RE}^{SCI , 1} - {N}_{RE}^{SCI , 2} ; \qquad ( 1 )$$

where: n_{PRB} is the number of PRBs occupied by the PSSCH,

$${N}_{RE}^{SCI , 1}$$

is the number of REs (including REs occupied by the DMRS of the PSCCH) occupied by the first-stage SCI,

$${N}_{RE}^{SCI , 2}$$

is the number of REs occupied by the second-stage SCI,

$${N}_{RE}^{′}$$

represents the number of reference REs available for PSSCH within a PRB and is determined by Equation (2):

$${N}_{RE}^{′} = {N}_{sc}^{RB} ( {N}_{symb}^{sh} - {N}_{symb}^{PSFCH} ) - {N}_{oh}^{PRB} - {N}_{RE}^{DMRS} ; \qquad ( 2 )$$

where:

$${N}_{sc}^{RB} = 12$$

represents the number or subcarriers in a PRB,

$${N}_{symb}^{sh}$$

represents the number of symbols available for sidelink in a slot, excluding the last GP symbol and the first symbol for AGC.

$${N}_{symb}^{PSFCH} = 0 or 3 ,$$

whose specific value is indicated by a “PSFCH symbol number” field in the first-stage SCI, and is a reference value of the number of symbols occupied by the PSFCH. The value of

$${N}_{oh}^{PRB}$$

is configured by a Radio Resource Control (RRC) layer parameter, and is used to represent a reference value of the number of REs occupied by PT-RS and CSI-RS.

$${N}_{RE}^{DMRS}$$

represents an average number of DMRS REs in a slot, and is related to the allowed DMRS pattern in the resource pool, as illustrated in Table 1.

TABLE 1
Correspondence of allowed DMRS patterns in resource pool and
${N}_{RE}^{DMRS}$

| DMRS pattern | ${N}_{RE}^{DMRS}$ |
|---|---|
| {2} | 12 |
| {3} | 18 |
| {4} | 24 |
| {2, 3} | 15 |
| (2, 4} | 18 |
| {3, 4} | 21 |
| {2, 3, 4} | 18 |

### 7. Sidelink DMRS

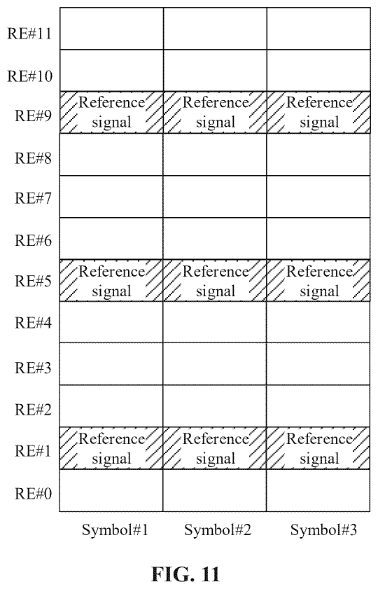

In NR-V2X, the DMRS pattern of PSCCH is the same as that of the NR Physical Downlink Control Channel (PDCCH), that is, DMRS exists on OFDM symbols of each PSCCH, and is located on {#1, #5, #9} REs of one PRB in the frequency domain, as illustrated in FIG. 11. The DMRS sequence of PSCCH is generated by Equation (3):

$${r}_{l} ( m ) = \frac{1}{\sqrt{2}} ( 1 - 2 c ( m ) ) + j \frac{1}{\sqrt{2}} ( 1 - 2 c ( m + 1 ) ) ; \qquad ( 3 )$$

where the pseudo-random sequence c(m) is initialized by

$${c}_{init} = ( {2}^{17} ( {N}_{symb}^{slot} {n}_{s , f}^{μ} + l + 1 ) ( 2 {N}_{ID} + 1 ) + 2 {N}_{ID} ) mod {2}^{31} ,$$

in which l is an index of an OFDM symbol where the DMRS is located in a slot,

$${n}_{s , f}^{μ}$$

is an index or the slot where the DMRS is located in the system frame,

$${N}_{symb}^{slot}$$

represents the number of OFDM symbols in a slot, N_{ID}∈{0, 1, . . . , 65535}. The specific value of N_{ID} n a resource pool is configured by the network or pre-configured.

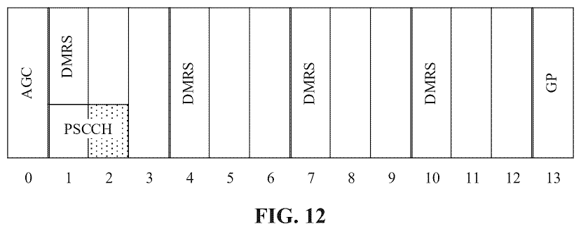

The NR-V2X draws on a design in a NR Uu interface and employs multiple time-domain PSSCH DMRS patterns. In a resource pool, the number of available DMRS patterns is related to the number of PSSCH symbols in the resource pool. For a specific number of PSSCH symbols (including the first AGC symbol) and specific number of PSCCH symbols, the available DMRS patterns and positions of each DMRS symbol in respective patterns are illustrated in Table 2. FIG. 12 provides a schematic diagram of time domain positions of four DMRS symbols when PSSCH has 13 symbols.

TABLE 2
Numbers and positions of DMRS symbols under different number
of PSSCH symbols and different number of PSCCH symbols

| Number of | | | | | | |
|---|---|---|---|---|---|---|
| PSSCH | | | | | | |
| symbols | Positions of DMRS symbols (relative to position of first AGC symbol) | | | | | |
| (including | Number of PSCCH symbols is 2 | | | Number of PSCCH symbols is 3 | | |
| first AGC | Number of DMRS symbols | | | Number of DMRS symbols | | |
| symbol) | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

If multiple time domain DMRS pattern is configured in the resource pool, a specific time domain DMRS pattern to be used is selected by sending UE and indicated in the first-stage SCI. Such design allows high-speed moving UE to select a high-density DMRS pattern, thereby ensuring the accuracy of channel estimation, while for low-speed moving UE, a low-density DMRS pattern may be adopted, thereby improving spectral efficiency.

The generation manner of PSSCH DMRS sequence is almost identical to that of PSCCH DMRS sequence, with the only difference being that in the initialization formula Cin of the pseudo-random sequence c(m),

$${N}_{ID} = {\sum }_{i = 0}^{L - 1} {p}_{i} \cdot {2}^{L - 1 - i} ,$$

where pᵢ is an i-th bit Cyclic Redundancy Check (CRC) of the PSCCH for scheduling the PSSCH, and L=24, which is the number of bits for PSCCH CRC.

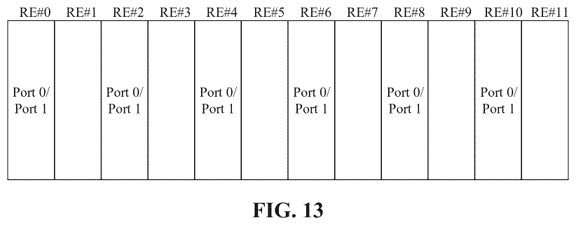

NR PDSCH and PUSCH support two frequency domain DMRS patterns, namely, DMRS frequency domain type 1 and DMRS frequency domain type 2, and for each frequency domain type, there are two different types of single-symbol DMRS and double-symbol DMRS. Single-symbol DMRS frequency domain type 1 supports 4 DMRS ports, and single-symbol DMRS frequency domain type 2 may support 6 DMRS ports. In a case of double-symbol DMRS, the number of all supported ports is doubled. However, in the NR-V2X, since the PSSCH only needs to support two DMRS ports at most, only a single-symbol DMRS frequency domain type 1 is supported, as illustrated in FIG. 13.

### 8. Sidelink Channel State Information Reference Signal (CSI-RS)

In order to better support unicast communication, SL CSI-RS is supported in NR-V2X, and the SL CSI-RS will only be sent when the following three conditions are met:
1) UE sends a corresponding PSSCH, that is, the UE cannot send SL CSI-RS only;
2) Sidelink CSI reporting is activated by higher-layer signaling;
3) under a condition that sidelink CSI reporting is activated by the higher-layer signaling, corresponding bits in the second-stage SCI sent by the UE trigger the sidelink CSI reporting.

The maximum number of ports supported by SL CSI-RS is 2. When there are two ports configured, SL CSI-RSs for different ports are multiplexed via code division on two adjacent REs within the same OFDM symbol. The number of SL CSI-RSs for each port within one PRB is 1, that is, a density is 1. Therefore, within a PRB, the SL CSI-RS will at most appear only on one OFDM symbol, and a specific position of the OFDM symbol is determined by the sending terminal. In order to avoid affecting the resource mapping of the PSCCH and the second-stage SCI, the SL CSI-RS cannot be located in the same OFDM symbol as the PSCCH and the second-stage SCI. Since the channel estimation accuracy is higher on the OFDM symbol where the PSSCH DMRS is located, and the SL CSI-RS for the two ports will occupy two consecutive REs in the frequency domain, the SL-CSI-RS also cannot be sent on the same OFDM symbol as the PSSCH DMRS. The position of the OFDM symbol where the SL CSI-RS is located is indicated by a parameter sl-CSI-RS-FirstSymbol in the PC5 RRC.

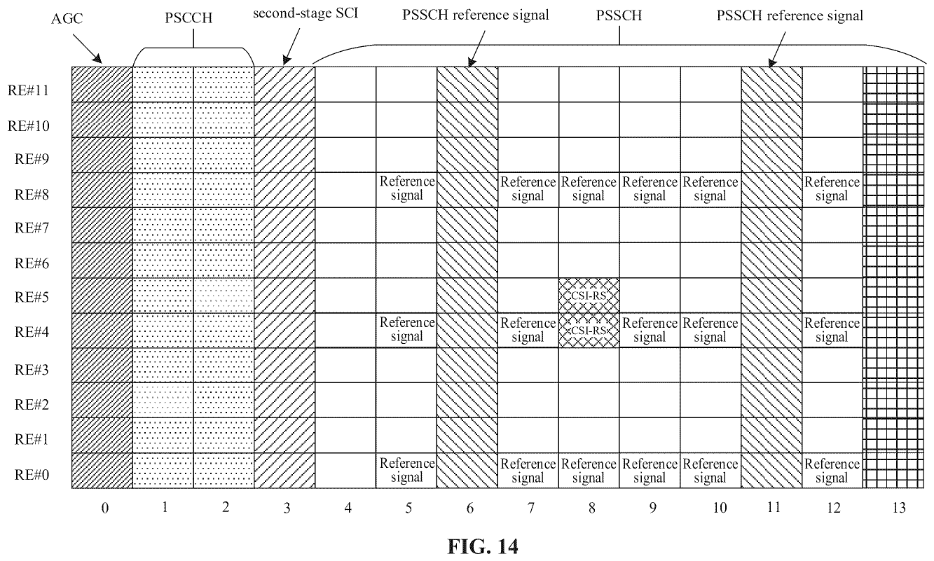

The position of the first RE occupied by the SL CSI-RS within one PRB is indicated by the parameter sl-CSI-RS-FreqAllocation in the PC5 RRC. If the SL CSI-RS is configured with one port, the parameter is a bitmap with a length of 12 bits, corresponding to 12 REs in one PRB. If the SL CSI-RS is configured with two ports, the parameter is a 6-bit bitmap, in which case the SL CSI-RS occupies two REs 2f(1) and 2f(1)+1, where f(1) indicates an index of a bit set to 1 in the above bitmap. The frequency domain position of the SL CSI-RS is also determined by the sending terminal, but the determined frequency domain position of the SL CSI-RSs must not conflict with a PT-RS. FIG. 14 illustrates a schematic diagram of time domain and frequency domain positions of SL CSI-RSs. In FIG. 14, the number of ports for SL CSI-RS is 2, sl-CSI-RS-FirstSymbol is 8, sl-CSI-RS-FreqAllocation is [b₅, b₄, b₃, b₂, b₁, b₀]=[0, 0, 0, 1, 0, 0].

### 9. 5G NR-Unlicensed (NR-U) Spectrum Communication

The NR system introduced in 3GPP R15 standard is a communication technology for use on both legacy and newly licensed spectrum. The NR system can achieve seamless cellular network coverage, high spectral efficiency, high peak rates, and high reliability. In Long Term Evolution (LTE) systems, the use of unlicensed spectrum (or license-exempt spectrum) as a complementary frequency band of licensed spectrum for cellular networks has been implemented. Similarly, NR systems may also use unlicensed spectrum as part of 5G cellular network technology to provide services to users. In 3GPP R16 standard, NR systems used on unlicensed spectrum, called NR-unlicensed (NR-U), are discussed.

The NR-U system supports two networking modes, including licensed spectrum assisted access and unlicensed spectrum standalone access. The licensed spectrum assisted access needs to access the network through the licensed spectrum, and the unlicensed spectrum is used as a secondary carrier. The unlicensed spectrum standalone access allows independent networking standalone solely through the unlicensed spectrum, and the UE may access the network directly through the unlicensed spectrum. A range of unlicensed spectrum used by the NR-U system introduced in 3GPP R16 is concentrated on frequency bands of 5 GHz and 6 GHz, such as 5925 MHz-7125 MHz in United States America, or 5925 MHz-6425 MHz in Europe. In the R16 standard, a new band 46 (i.e., 5150 MHz-5925 MHz) is defined as an unlicensed spectrum. The unlicensed spectrum is a spectrum divided by countries and regions for radio device communication.

The spectrum is usually considered as a shared spectrum, that is, a communication device may use the spectrum as long as they meet regulatory requirements set by countries or regions for the spectrum, without the need to apply for an exclusive spectrum license from a dedicated spectrum management agency of the countries or regions. Since the use of unlicensed spectrum needs to meet the requirements of specific regulations in each country and region, for example, the communication device uses the unlicensed spectrum according to a principle of “Listen Before Talk (LBT)”, and thus NR technology needs to be enhanced accordingly to adapt to the regulatory requirements of unlicensed frequency bands while efficiently utilizing unlicensed spectrum to provide services. In the 3GPP R16 standard, the standardization of NR-U technology mainly covered the following aspects: a channel monitoring process; an initial access procedure; a control channel design; a Hybrid Automatic Repeat reQuest (HARQ) and scheduling; and a grant-free transmission, etc.

### 10. Channel Monitoring: LBT

In order for various communication systems that use the unlicensed spectrum for wireless communication to coexist harmoniously on the spectrum, some countries or regions have stipulated regulatory requirements that must be met when using the unlicensed spectrum. For example, according to regulations in Europe, when using the unlicensed spectrum for communication, the communication device follows the principle of “LBT”, that is, the communication device needs to perform LBT or channel monitoring, before using channels in the unlicensed spectrum for signal transmission. Only when a channel monitoring result is that the channel is idle or LBT is successful, the communication device may send signals through the channel. If the channel monitoring result of the communication device on the channel is that the channel is busy or the LBT fails, the communication device cannot send signals through the channel. In addition, in order to ensure fairness in the use of spectrum resources of the shared spectrum, if the communication device performs LBT on the channels in the unlicensed spectrum successfully, the communication device may use the channel for communication transmission for no more than a certain duration. By limiting the maximum communication duration after a successful LBT, the mechanism allows different communication devices to have an opportunity to access the shared channel, thereby enabling different communication systems to coexist harmoniously on the shared spectrum.

Although channel monitoring is not a global regulation, because channel monitoring can bring benefits of interference avoidance and harmonious coexistence to the communication transmission between communication systems on the shared spectrum, in a design process of NR system on the unlicensed spectrum, channel monitoring must be supported by the communication devices in the system. From a perspective of system network layout, channel monitoring includes two mechanisms, one is LBT with Load Based equipment (LBE), also known as dynamic channel monitoring or dynamic channel occupancy, and the other is LBT with Frame Based Equipment (FBE), also known as semi-persistent channel monitoring or semi-persistent channel occupancy.

### 11. Dynamic Channel Monitoring

The dynamic channel monitoring may also be regarded as an LBE-based LBT manner. A channel monitoring principle of the dynamic channel monitoring is that the communication device performs LBT on a carrier of the unlicensed spectrum after the service arrives, and starts signal transmission on the carrier after the LBT is successful. The LBT manner for dynamic channel monitoring includes a Type1 channel access manner and a Type2 channel access manner. The Type1 channel access manner is multi-slot channel detection based on random backoff with adjustable contention window, where a corresponding Channel Access Priority Class (CAPC) p may be selected according to a priority of the service to be sent. The Type2 channel access manner is a channel access manner based on a fixed-length monitoring slot, where the Type2 channel access manner includes a Type2A channel access, a Type2B channel access, and a Type2C channel access. The Type1 channel access manner is mainly used for the communication device to initiate channel occupancy, and the Type2 channel access manner is mainly used for the communication device to share channel occupancy. It is to be noted that in a special case, when the base station initiates channel occupancy for sending a Synchronization Signal/Physical Broadcast Channel (SS/PBCH) block in a Discover Reference Symbol (DRS) window and unicast data transmission for the UE is not included in the DRS window, if a length of the DRS window does not exceed Ims and a duty cycle of transmission within the DRS window does not exceed 1/20, then the base station may use Type 2A channel access to initiate channel occupancy.

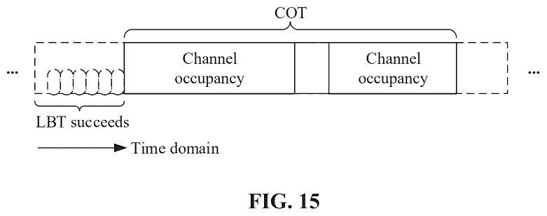

FIG. 15 illustrates an example of a channel occupancy time obtained by a communication device after a successful LBT on a channel of an unlicensed spectrum as well as the use of resources within the channel occupancy time for signal transmission.

### 12. Default Channel Access Manner on the Base Station Side: Type1 Channel Access

Taking a base station as an example, channel access parameters corresponding to a channel access priority p on the base station side are illustrated in Table 3. In Table 3, mₚ refers to the number of backoff slots corresponding to the channel access priority p, CWₚ refers to a size of a Contention Window (CW) corresponding to channel access priority p, CW_{min,p} refers to a minimum value of CWₚ corresponding to channel access priority p, CW_{max,p} refers to a maximum value of CWₚ corresponding to channel access priority p, T_{mcot,p} refers to a maximum length of channel occupancy time corresponding to channel access priority p.

If the channel access process is completed, the base station may use the channel for the transmission of the services to be sent. The maximum time length for which the base station may use the channel for transmission cannot exceed T_{mcot,p}.

TABLE 3
channel access parameters corresponding
to different channel access priorities p

| Channel | | | | | |
|---|---|---|---|---|---|
| access | | | | | Values of allowed |
| priority (p) | mₚ | CW_{min, p} | CW_{min, p} | T_{mcot, p} | CWₚ |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {1, 15, 31, 63, 127, |
| | | | | 10 ms | 255, 511, 1023} |

### 13. Channel Occupancy Time Sharing on the Base Station Side

After the base station initiates a Channel Occupancy Time (COT), it may not only use resources within the COT for downlink transmission, but also share them with the UEs for uplink transmission. When the resources in the COT are shared with the UE for uplink transmission, the channel access manner that the UE may use is Type2A channel access, Type2B channel access, or Type2C channel access, where all of the Type2A channel access, Type2B channel access, and Type2C channel access are channel access manners based on fixed-length monitoring slots.

### Type 2A Channel Access:

The channel detection manner of the UE is single-slot channel detection of 25 μs. Specifically, under Type2A channel access, the UE may perform channel monitoring for 25 μs before transmission starts, and perform transmission after the channel monitoring is successful.

### Type 2B Channel Access:

The channel detection manner of the UE is single-slot channel detection of 16 μs. Specifically, under Type2B channel access, the UE may perform channel monitoring for 16 μs before transmission starts, and perform transmission after the channel monitoring is successful. The gap between a starting position of the transmission and an ending position of a last transmission is 16 μs.

### Type 2C Channel Access:

UE performs transmission without channel detection after the gap. Specifically, under the Type 2C channel access, UE may perform transmission directly, where the gap size between the starting position of the transmission and the ending position of the last transmission is less than or equal to 16 μs. The duration of the transmission does not exceed 584 μs.

### 14. Channel Access Parameter Indication (Including Cyclic Prefix Extension (CPE))

In the NR-U system, when the UE is scheduled to transmit a Physical Uplink Shared Channel (PUSCH) or a Physical Uplink Control Channel (PUCCH), the base station may indicate a channel access manner corresponding to the PUSCH or the PUCCH by Downlink Control Information (DCI) carrying an uplink (UL) grant or a downlink (DL) grant. Since some channel access manners need to meet a gap requirement of 16 μs or 25 μs, the UE may ensure the gap size between two transmissions by transmitting the CPE, and accordingly, the base station may indicate a CPE length of a first symbol for the uplink transmission of the UE.

In the specific indication, the base station may explicitly indicate channel access parameters such as CPE length, channel access manner, or channel access priority to the UE by joint coding. The following describes characteristics of indication manners of channel access parameters introduced in different DCI formats.

### 1) Fallback UL Grant for Scheduling PUSCH Transmission (DCI Format 0_0):

The standard predefines a set of joint indications for channel access manners and CPE lengths, as illustrated in Table 4. The fallback UL grant includes 2-bit LBT indication information for indicating jointly coded channel access manner and CPE length from the set illustrated in Table 4. The channel access manner and CPE length are used for PUSCH transmission. If the channel access manner is Type1 channel access, the UE selects the CAPC independently according to a service priority.

### 2) Fallback DL Grant for Scheduling PDSCH Transmission (DCI Format 1_0):

The standard predefines a set of joint indications for channel access manners and CPE lengths, as illustrated in Table 4. The fallback DL grant includes 2-bit LBT indication information for indicating jointly coded channel access manner and CPE length from the set illustrated in Table 4. The channel access manner and CPE length are used for transmission of a PUCCH, where the PUCCH may carry either an ACKnowledgement (ACK) or a Negative ACKnowledgement (NACK) corresponding to PDSCH. If the channel access manner is Type1 channel access, the UE determines that the channel access priority for PUCCH transmission is CAPC=1.

TABLE 4
Set of joint indications for channel
access manners and CPE lengths

| LBT | | |
|---|---|---|
| indication | channel access manner | CPE length |
| 0 | Type2C channel access | C2* symbol length -16 μs-TA |
| 1 | Type2A channel access | C3* symbol length -25 μs-TA |
| 2 | Type2A channel access | C1* symbol length -25 μs |
| 3 | Type1 channel access | 0 |

In Table 4, a value of C1 is specified by a protocol. When a subcarrier spacing is 15 kHz and 30 kHz, C1=1. When the subcarrier spacing is 60 kHz, C1=2. Values of C2 and C3 are configured by higher layer parameters. When the subcarrier spacing is 15 kHz and 30 kHz, values of C2 and C3 range from 1 to 28. When the subcarrier spacing is 60 kHz, the values of C2 and C3 range from 2 to 28.

### 3) Non-Fallback UL Grant for Scheduling PUSCH Transmission (DCI Format 0_1):

The higher layer configures an LBT parameter indication set, and the LBT parameter indication set includes at least one jointly coded channel access manner, CPE length and CAPC. The non-fallback UL grant includes LBT indication information for indicating a jointly coded channel access manner, CPE length and CAPC from the LBT parameter indication set. The channel access manner, the CPE length and the CAPC are used for PUSCH transmission. If the indicated channel access manner is Type2 channel access, the CAPC indicated at the same time is a CAPC used by the base station when obtaining the COT. The LBT indication information includes at most 6 bits.

### 4) Non-Fallback DL Grant for Scheduling PDSCH Transmission (DCI Format 1_1):

The higher layer configures an LBT parameter indication set, and the LBT parameter indication set includes at least one jointly coded channel access manner and CPE length. The non-fallback downlink grant includes LBT indication information for indicating a jointly coded channel access manner and CPE length from the LBT parameter indication set. The channel access manner and the CPE length are used for PUCCH transmission, and the PUCCH may carry ACK or NACK information corresponding to the PDSCH. If the channel access manner is Type1 channel access, the UE determines that the channel access priority for PUCCH transmission is CAPC=1. The LBT indication information includes at most 4 bits.

In addition to the above explicit indication, the base station may also implicitly indicate the channel access manner within the COT. When the UE receives the UL grant or the DL grant sent by the base station indicating that the channel access type corresponding to the PUSCH or the PUCCH is Type1 channel access, if the UE can determine that the PUSCH or the PUCCH is within COT of the base station, for example, the UE receives DCI format 2 0 sent by the base station and determines that the PUSCH or the PUCCH is within the COT of the base station according to the DCI format 2_0, then the UE may update the channel access type corresponding to the PUSCH or the PUCCH to Type2A channel access instead of using the Type1 channel access.

The related technologies/terms involved in the embodiments of the present disclosure have been briefly described above, and will not be repeated in the following embodiments.

It is to be understood that the terms “system” and “network” of the present disclosure are often used interchangeably herein. In the present disclosure, the term “and/or” is used to describe an association relationship of associated objects, and represents that there may be three relationships. For example, A and/or B may represent the following three situations: i.e., independent existence of A, existence of both A and B and independent existence of B. In addition, the character “/” in the present disclosure generally represents that an “or” relationship is formed between the previous and next associated objects. It is to be understood that the term “indicate” in embodiments of the present disclosure may be a direct indication, may be an indirect indication, or may indicate an association relationship. For example, A indicates B, meaning that A directly indicates B, for example, B may be obtained through A. It may also mean that A indirectly indicates B, for example, A indicates C, and B may be obtained by C. It may also indicate that there is an association relationship between A and B. It is to be understood that “correspond” in the description of embodiments of the present disclosure may mean that there is a direct correspondence or an indirect correspondence relationship between the two, may also mean that there is an association relationship between the two, may also be a relationship between indication and being indicated, configuration and being configured, etc. It is also to be understood that the “predefined” or “predefined rules” referred to in embodiments of the present disclosure may be implemented by pre-storing corresponding codes, tables, or other manners that may be used to indicate relevant information in devices (e.g., including terminal devices and network devices), the specific implementation of which is not limited by the present disclosure.

It is also to be understood that the specific form of the terminal is not limited in the embodiments of the present disclosure. As an example, the terminal in the embodiments of the present disclosure may refer to an access terminal, user equipment (UE), a subscriber unit, a subscriber station, a mobile station, a mobile platform, a remote station, a remote terminal, a mobile device, a user terminal, a terminal device, a wireless communication device, a user agent, or a user device. The access terminal may be a cellular phone, a cordless phone, a session initiation protocol (SIP) telephone, an IoT device, a satellite handheld terminal, a wireless local loop (WLL) station, a personal digital assistant (PDA), a handheld device with wireless communication function, a computing device or other processing device connected to a wireless modem, an in-vehicle device, a wearable device, a terminal device in the 5G network or a terminal device in the future evolved network, etc.

In existing SL technologies, it is assumed that all terminals in the system have identical capabilities, such as supporting the same bandwidth, the same transmit power, and the like. Therefore, in the related art, each PSSCH corresponds to feedback resource of one PSFCH. However, if each PSSCH corresponding the feedback resource of one PSFCH, the terminal needs to frequently perform transmission/reception of PSFCH, which leads to large power energy consumption for some terminals with weak capabilities (such as RedCap UE).

In view of this, the present disclosure provides a method and an apparatus for sidelink feedback information transmission, a terminal, a chip, and a storage medium. The method may, for example, be applied to the sidelink unlicensed frequency bands.

In the method, a first terminal may send a first transport block to a second terminal on a plurality of first PSSCH resources, and receive first feedback information from the second terminal on a first PSFCH resource, where the first feedback information is feedback for reception of the first transport block by the second terminal on the plurality of first PSSCH resources. That is, after sending a first transport block to the second terminal on a plurality of first PSSCH resources, the first terminal may receive first feedback information from the second terminal on a first PSFCH resource, and thus may obtain the situation of the reception of the first transport block by the second terminal on the plurality of first PSSCH resources according to the first feedback information. In this way, it is not necessary to have each PSSCH correspond to a PSFCH feedback resource, which helps avoiding frequent transmission/reception of PSFCH between terminals (for example, between the first terminal and the second terminal), thereby achieving energy saving of the terminals.

In order to facilitate understanding of the technical solution of the embodiments of the present disclosure, the technical solution of the present disclosure will be described in detail by specific embodiments below. The above related technologies may be combined with the technical solution of the embodiments of the present disclosure arbitrarily as optional solutions, all of which belong to the protection scope of the embodiments of the present disclosure. Embodiments of the present disclosure include at least some of the following.

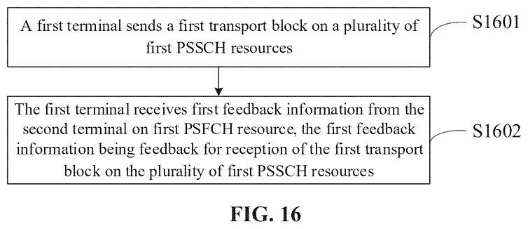

FIG. 16 is a schematic flowchart of a method for sidelink feedback information transmission provided by an embodiment of the present disclosure. As illustrated in FIG. 16, the method may include the following operations S1601 and S1602.

At S1601, a first terminal sends a first transport block to a second terminal on a plurality of second PSSCH resources.

In this operation, the first terminal may send the first transport block to the second terminal over a plurality of first PSSCH resources. Correspondingly, the second terminal may receive the transport block from the first terminal over the plurality of PSSCH resources.

In an embodiment of the present disclosure, each PSSCH resource (such as each first PSSCH resource) may be used for one transmission of the first transport block. Therefore, the first terminal sending the first transport block on multiple (e.g., N) first PSSCH resources, may also be understood as that the first terminal sends the first transport block to the second terminal multiple times (e.g., N times). N is an integer greater than 1.

At S1602, the first terminal receives first feedback information from the second terminal on a first PSFCH resource, the first feedback information being feedback for reception of the first transport block by the second terminal on the plurality of first PSSCH resources.

In this operation, the second terminal may send first feedback information over first PSFCH resource, and the first PSFCH resource may correspond to/be associated with the plurality of first PSSCH resources. Correspondingly, the first terminal may receive the first feedback information from the second terminal over the first PSFCH resource. The first feedback information is feedback about the reception of the first transport block by the second terminal on the plurality of first PSSCH resources.

That is, after sending a first transport block to the second terminal on a plurality of first PSSCH resources, the first terminal may receive first feedback information from the second terminal on a first PSFCH resource, and thus may obtain the situation of the reception of the first transport block by the second terminal on the plurality of first PSSCH resources according to the first feedback information. In this way, it is not necessary to perform PSFCH feedback every time the first transport block is transmitted, which helps avoid frequent transmission/reception of PSFCH between the first terminal and the second terminal, thereby achieving energy saving of the terminals.

In some embodiments, if the second terminal correctly receives the first transport block on at least one first PSSCH resource of the plurality of first PSSCH resources, then the first feedback information indicates that the second terminal has correctly received the first transport block. If the second terminal does not correctly receive the first transport block on each of the plurality of first PSSCH resources, then the first feedback information indicates that the second terminal has not correctly received the first transport block.

The second correctly receiving the first transport block may mean that the terminal has received and successfully decoded the transport block.

As an implementation, in a case where the first feedback information indicates that the second terminal has correctly received the first transport block, the first feedback information may include ACK. In a case where the first feedback information indicates that the second terminal has not correctly received the first transport block, the first feedback information may include NACK.

That is, if the first transport block is correctly received by the second terminal over at least one first PSSCH resource of the plurality of first PSSCH resources, then it indicates that the second terminal has correctly received the first transport from the first terminal over the plurality of first PSSCH resources, and ACK may be carried in the first feedback information. If the first transport block is not correctly received by the second terminal over each of the plurality of first PSSCH resources, then it indicates that the second terminal has not correctly received the first transport over the plurality of first PSSCH resources, and thus NACK may be carried in the first feedback information.

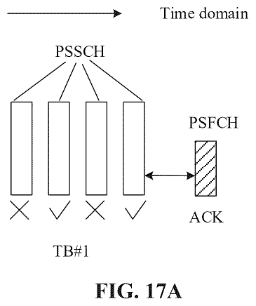

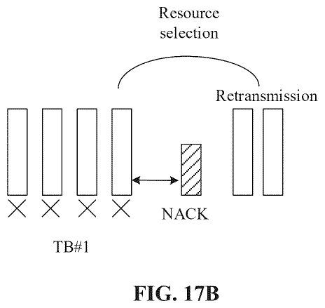

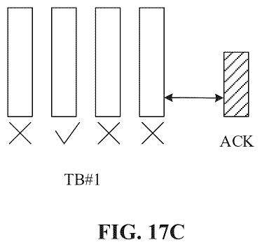

In order for description, FIGS. 17A to 17C illustrate examples of sidelink feedback information transmission provided by an embodiment of the present disclosure. The blank rectangular boxes represent PSSCH resources used for transmission of TB #1 (the first transmission block), while the shaded rectangular box represents PSFCH resource.

As illustrated in in FIGS. 17A-C, the first terminal may send TB #1 on four PSSCH resources (i.e., first PSSCH resources) to the second terminal, and may receive the first feedback information from the second terminal on one PSFCH resource (i.e., first PSFCH resource).

In FIG. 17A, the first and third transmissions of TB #1 are not correctly received by the second terminal, and the second and fourth transmissions of TB #1 are correctly received by the second terminal. That is, TB #1 is correctly received by the second terminal twice. Therefore, the second terminal may feed back ACK to the first terminal on the PSFCH resource.

In FIG. 17C, the first, third and fourth transmissions of TB #1 are not correctly received by the second terminal, and the second transmission of TB #1 is correctly received by the second terminal. That is, TB #1 is correctly received by the second terminal once. Therefore, the second terminal may feed back ACK to the first terminal on the PSFCH resource.

As illustrated in FIG. 17B, the first terminal may send TB #1 on the first four PSSCH resources (i.e., first PSSCH resources) to the second terminal, and may receive the first feedback information from the second terminal on one PSFCH resource (i.e., first PSFCH resource) after the four PSSCH resources. Herein, the four transmissions of TB #1 are not correctly received by the second terminal, and thus the second terminal may feed back NACK to the first terminal on the PSFCH resource.

In some embodiments, time-frequency positions of the plurality of first PSSCH resources and the first PSFCH resource are determined by the first terminal during one resource selection process.

For example, in FIG. 17A and FIG. 17C, PSSCH resources and PSFCH resource may be determined by the first terminal during one resource selection process. For another example, in FIG. 17B, the first four PSSCH resources and one PSFCH after them may be determined by the first terminal during one resource selection process.

In some embodiments, in a case where the first feedback information indicates that the second terminal has not correctly received the first transport block, the method may further include the flowing operations 11) and 12).

At operation 11), the first terminal sends the first transport block to the second terminal on a plurality of second PSSCH resources. Correspondingly, the second terminal receives the first transport block from the first terminal on the plurality of second PSSCH resources.

Each second PSSCH resource may be used for one transmission of the first transport block. Therefore, the first terminal sending the first transport block on multiple (e.g., N′) second PSSCH resources, may also be understood that the first terminal sends the first transport block to the second terminal multiple times (e.g., N′ times). N′ is an integer greater than 1.

At operation 12), the second terminal sends second feedback information on a second PSFCH resource, and the second PSFCH resource may correspond to/be associated with the plurality of second PSSCH resources. Correspondingly, the first terminal may receive the second feedback information from the second terminal on the second PSFCH resource. The second feedback information is feedback for reception of the first transport block by the second terminal on the plurality of second PSSCH resources.

That is, in a case where the first feedback information indicates that the second terminal has not correctly received the first transport block, for example, when the first feedback information carries an NACK, the first terminal may retransmit the first transport block on multiple second PSSCH resources.

As an example, in FIG. 17B, the second terminal feeds back an NACK on a PSFCH resource (i.e., the first PSFCH resource). Thus, the first terminal may retransmit the TB #1 (i.e., the first transport block) to the second terminal on two retransmission PSSCH resources.

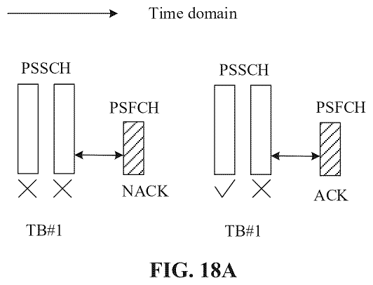

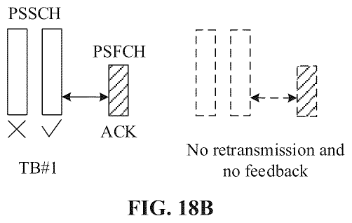

As another example, FIGS. 18A-B illustrate another example for sidelink feedback information transmission provided by an embodiment of the present disclosure. Herein, the blank rectangular boxes represent PSSCH resources used for transmission of TB #1 (i.e., the first transmission block), while the shaded rectangular box represents PSFCH resource. As illustrated in FIG. 18B, the second terminal fed back an NACK on a first one PSFCH resource (i.e., first PSFCH resource), and thus the first terminal may resend TB #1 on (i.e., the first transport bock) to the second terminal on two PSSCH resources (i.e., second PSSCH resources) after the first PSFCH resource.

It may be understood that in an embodiment of the present disclosure, if the first feedback information indicates that the second terminal has correctly received the first transport block, then the first terminal may not need to retransmit the first transport block. For example, in FIG. 18B, the second terminal has fed back a ACK on the first one PSFCH resource (i.e., the first PSFCH resource), and thus the first terminal does not need to retransmit TB #1. Correspondingly, the second terminal also does not need to provide feedback.

In the embodiment, after sending a first transport block to the second terminal on a plurality of second PSSCH resources, the first terminal may receive first feedback information from the second terminal on a second PSFCH resource, and may obtain the reception situation of the first transport block by the second terminal on the plurality of second PSSCH resources according to the second feedback information. In this way, frequent transmission/reception of PSFCH between the first terminal and the second terminal can be avoided, thereby achieving energy saving of the terminals.

It is to be noted that since initial transmission is critical for the transmission of transport blocks, in some scenarios, the number of the first PSSCH resources may be equal to 1, and the number of the second PSSCH resources may be greater than 1. That is, the PSSCH resources (first PSSCH resources) for initial transmission of the first transport block may correspond to one PSFCH resource, and the PSSCH resources (multiple second PSSCH resources) for retransmission of the first transport block may correspond to another PSFCH resource. In this way, the performance of data transmission can be improved while reducing the power consumption of the terminals. In other scenarios, the number of the first PSSCH resources may be greater than 1, and the number of the second PSSCH resources may be equal to 1.

In some embodiments, if the second terminal correctly receives the first transport block on at least one second PSSCH resource of the plurality of second PSSCH resources, then the second feedback information indicates that the second terminal has correctly received the first transport block. If the second terminal does not correctly receive the first transport block on each of the plurality of first PSSCH resources, then the second feedback information indicates that the second terminal has not correctly received the first transport block.

As an implementation, in a case where the second feedback information indicates that the second terminal has correctly received the first transport block, the second feedback information may include a ACK. In a case where the second feedback information indicates that the second terminal has not correctly received the first transport block, the second feedback information may include an NACK.

That is, if the second terminal has correctly received the first transport block on at least one second PSSCH resource of the plurality of second PSSCH resources, then it indicates that the second terminal has correctly received the first transport from the first terminal over the plurality of second PSSCH resources, and the second feedback information may carry the ACK. If the second terminal has not correctly received the first transport block on each of the plurality of second PSSCH resources, then it indicates that the second terminal has not correctly received the first transport over the plurality of second PSSCH resources, and thus the first feedback information may carry the NACK.

As illustrated in FIG. 18A, the second terminal has correctly received TB #1 on one of the last two PSSCH resources (the second PSSCH resources), and thus the second terminal may feed back a ACK to the first terminal on the second one PSFCH resource (i.e., the second PSFCH resource) in the figure.

In some embodiments, time-frequency positions of the plurality of first PSSCH resources, the first PSFCH resource, the plurality of second PSSCH resources and the second PSFCH resource are determined by the first terminal during one resource selection process; or time-frequency positions of the plurality of second PSSCH resources and the second PSFCH resource are determined by the first terminal in a case where the first feedback information indicates that the second terminal has not correctly received the first transport block.

That is, the manner in which the first terminal performs resource selection may include the following manner 1 or manner 2.

In manner 1, the first terminal may determine the time-frequency positions of the plurality of first PSSCH resources, the first PSFCH resource, the plurality of second PSSCH resources and the second PSFCH resource at a time.

For example, in FIG. 18A, the first two PSSCH resources (first PSSCH resources), the first one PSFCH resource (first PSFCH resource), the last two PSSCH resources (second PSSCH resources), and the second one PSFCH resources (second PSFCH resource) may be determined by the first terminal in one resource selection process.

Since the plurality of first PSSCH resources and the plurality of second PSSCH resources may be determined in one resource selection process, the interval between the plurality of first PSSCH resources and the plurality of second PSSCH resources may be set to be short by the first terminal when performing resource selection, thereby reducing the delay of data transmission.

In manner 2, the first terminal may first determine the time-frequency positions of the plurality of first PSSCH resources and the first PSFCH resource. If the first feedback information indicates that the second terminal has not correctly received the first transport block, for example, the first feedback information contains NACK, then the second terminal may perform resource selection again to select/determine the time-frequency positions of the plurality of second PSSCH resources and the second PSFCH resource.

For example, in FIG. 17B, during a resource selection process, the first terminal may first determine the time-frequency positions of the first four PSSCH resources (first PSSCH resources) and the time-frequency position of a PSFCH resource (first PSFCH resource) after them. If the second terminal feeds back an NACK on the PSFCH resource, the first terminal may perform resource selection again to select/determine PSSCH resources (i.e., the second PSSCH resources) for retransmission of TB #1. For example, in FIG. 17B, the first terminal selects two PSSCH resources for retransmission of TB #1. In some embodiments, the second PSFCH resource (not shown in FIG. 17B) may be determined in the same resource selection process along with the second PSSCH resources.

In the manner 2, since the time-frequency positions of the plurality of second PSSCH resources and the second PSFCH resource are determined in a case where the second terminal does not correctly receive the first transport block, that is, if the second terminal has correctly received the first transport block, then the second terminal may not need to perform resource selection again, Therefore, waste of resources is greatly reduced.

In some embodiments, when the first terminal sends a first transport block (for example, sending the first transport block on multiple first PSSCH resources) and when the first terminal receives the first feedback information, the first terminal and the second terminal are in a discontinuous reception (DRX) active state. Correspondingly, when the second terminal receives the first transport block (for example, receiving the first transport block on multiple first PSSCH resources) and when the second terminal sends the first feedback information, the first terminal and the second terminal are also in DRX active state.

Herein, a terminal (such as the first terminal, or the second terminal) being in the DRX activation state, may be understood as that the terminal has enabled transmission/reception.

In some embodiments, when the first terminal sends a first transport block (for example, sending the first transport block on multiple first PSSCH resources and multiple second PSSCH resources), and when the first terminal receives the first feedback information and the second feedback information, the first terminal and the second terminal are in a DRX active state. Correspondingly, when the second terminal receives the first transport block (for example, receiving the first transport block on multiple first PSSCH resources and multiple second PSSCH resources), and when the second terminal sends the first feedback information and the second feedback information, the first terminal and the second terminal are also in DRX active state.

The method of the present embodiment enables to realize collaborative operation of the DRX function and the SL feedback function, so that energy saving of terminals can be further achieved based on the characteristics of the DRX function.

In some embodiments, the plurality of first PSSCH resources and the first PSFCH resource may be located within an active state of a same DRX cycle; or the plurality of first PSSCH resources and the first PSFCH resource are located within active states of different DRX cycles.

Herein, being located in the active state of the same DRX cycle may also be understood as being located in one DRX active state for a terminal (such as the first terminal or the second terminal). Being located in the active states of different DRX cycles may also be understood as being located in two different DRX active states for a terminal (such as the first terminal or the second terminal), respectively.

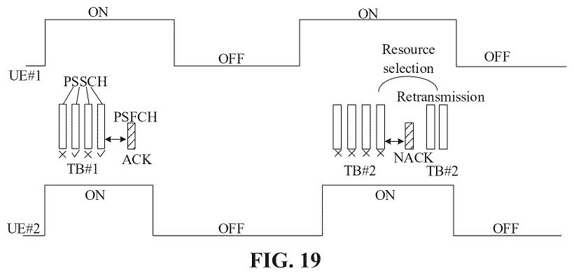

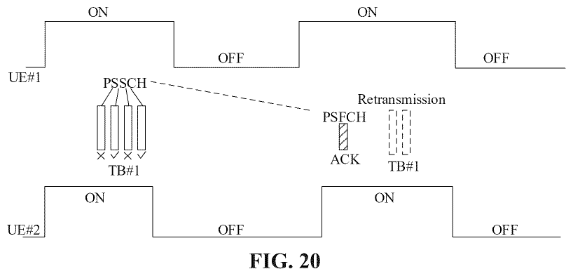

FIG. 19 and FIG. 20 illustrate two examples of collaborative operation of DRX function and SL feedback function provided by embodiments of the present disclosure. In the figures, ON indicates that the terminal is in DRX active state, and OFF indicates that the terminal is in DRX inactive state. In one possible case, as illustrated in FIG. 19, the PSSCHs for transmission of TB #1 (an example of the first transport block) and corresponding PSFCH are located in the active state of the same DRX cycle, and the first four PSSCHs for transmission of TB #1 (another example of the first transport block) and corresponding PSFCH are also located in the active state of the same DRX cycle. In another possible case, as illustrated in FIG. 20, the PSSCHs for transmission of TB #1 (which is an example of the first transport block) and corresponding PSFCH are located in the active states of different DRX cycles, respectively.

It should be understood that in some scenarios, the ON (start) and OFF (end) moments of the DRX active state for the first terminal and the second terminal are consistent. In other scenarios, for example, when the second terminal is a weak-capability terminal and the first terminal is a high-capability terminal, the occupancy time for the second terminal being in the DRX active state may be included in the occupancy time for the first terminal being in the DRX active state, or may also be consistent with the occupancy time for the first terminal being in the DRX active state. Here, the ON and OFF moments of the DRX activation state for the first terminal and the second terminal may be configured, for example, by the network.

In some embodiments, the plurality of first PSSCH resources and the first PSFCH resource are located within an active state of a same DRX cycle, which refers to that the plurality of first PSSCH resources and the first PSFCH resource are located within the active state of the same DRX cycle for the first terminal, and/or located within the active state of the same DRX cycle for the second terminal.

In one possible manner, the plurality of first PSSCH resources are located within an active state of a first DRX cycle. In this case, if a time interval between an ending time of a last first PSSCH resource of the plurality of first PSSCH resources and an ending time of an active state of the first DRX cycle is less than a first threshold, then the first PSFCH resource is located within an active state of a next DRX cycle for the first DRX cycle.

It can be understood that when a time interval between an ending time of a last first PSSCH resource of the plurality of first PSSCH resources and an ending time of an active state of the first DRX cycle is less than a first threshold, it indicates that there is insufficient time remaining in the current active state of the first DRX cycle. Thus, the second terminal may wait until the next DRX cycle to provide feedback, as illustrated in FIG. 20.

In some embodiments, the first threshold is a time domain length of the first PSFCH resource.

It may be understood that when a time interval between an ending time of a last first PSSCH resource of the plurality of first PSSCH resources and an ending time of an active state of the first DRX cycle is less than the time domain length of the first PSFCH resource, it indicates that there is insufficient time remaining in the current active state of the first DRX cycle for transmission of the first feedback information. Thus, the second terminal may wait until the next DRX cycle to send the first feedback information.

In some embodiments, if the channel occupancy time (COT) of the first terminal is contained in the time duration of the DRX active state, then the first terminal is capable of communicating with the second terminal in the COT. If the COT of the first terminal partially overlaps with the time duration of the DRX active state, then the first terminal is capable of communicating with the second terminal within a portion of the COT that overlaps.

Correspondingly, if COT of the second terminal is contained in the time duration of the DRX active state, then the second terminal is capable of communicating with the first terminal in the COT. If the COT of the second terminal partially overlaps with the time duration of the DRX active state, then the second terminal is capable of communicating with the first terminal within a portion of the COT that overlaps.

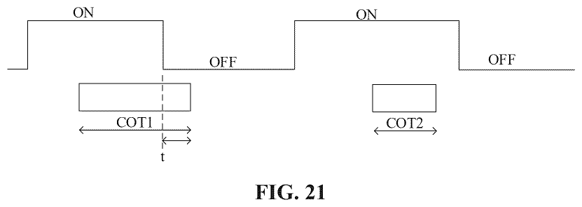

FIG. 21 illustrate one example of collaborative operation of DRX function and COT feedback function provided by an embodiment of the present disclosure, which may be applicable for the first terminal and the second terminal in the embodiments of the present disclosure. In the figures, ON indicates that the terminal is in DRX active state, and OFF indicates that the terminal is in DRX inactive state.

As illustrated in FIG. 21, COT2 is contained in the time duration of a DRX active state, so COT2 may be fully used, that is, the terminal may perform transmission/reception on time slot resources within the entire COT2. COT1 partially overlaps with the time duration of a DRX active state, where an overlapping part of the COT1 may be used, and a non-overlapping part of the COT1 (that is, COT1 after time t) cannot be used, that is, the terminal may not perform transmission/reception on the slot resources after time t within the COT1.

The method of the present embodiment clarifies the problem of using COT when the DRX function and the COT duration operate collaboratively, which avoids resource waste and invalid transmission, thereby improving resource utilization.

In some embodiments, the maximum number of transmissions of the first transport block is less than 32. Here, the maximum number of transmissions may include, for example, the total number of initial transmissions and retransmissions.

By way of example, the value of the maximum number L of transmissions of the first transport block may be less than 32 in prior art. For example, the value of L may be 4, 6, 8, 16, etc., or the value of L may be less than or equal to a second threshold. For example, the second threshold value is 16, and the value of L may be any integer from 1 to 16. Here, the value of L may be determined, for example, through configuration/pre-configuration.

According to the method of the embodiment, the maximum number of transmissions of one TB (e.g., the first transport block) may be limited to be in a small range. In the multiple transmissions of TB, the first few transmissions are more critical than the last few transmissions, and the transmission effect of the last few transmissions is significantly reduced. At the same time, considering that the power consumption caused by the large number of transmissions is also large, by limiting the maximum number of transmissions of TB, the power consumption of the terminal can be effectively reduced.

The method for sidelink feedback information transmission provided by the embodiments of the present disclosure has been described above. In order to facilitate understanding of the embodiments of the present disclosure, possible implementation schemes of the sidelink feedback information transmission method applicable to the embodiments of the present disclosure will be described below with reference to examples. For brevity, in the following example, the first terminal, the second terminal, and the first transport block are denoted as UE #1, UE #2, and TB #1, respectively.

Exemplarily, the solution of the embodiments of the present disclosure may include:
Scheme 1: reducing PSFCH resources and the number of PSFCH feedbacks;
Scheme 2: collaborative operation of DRX function and sidelink feedback function;
Scheme 3: collaborative operation of COT duration and DRX function;
Scheme 4: reducing the number of retransmissions of one TB (maximum number of transmissions).

The above four schemes are introduced below.

### Scheme 1

In Scheme 1, by reducing PSFCH resources and the number of PSFCH feedbacks, it is possible to avoid a large amount of power consumption caused by terminals (such as weak-capability terminals) frequently sending/receiving feedback information.

In the first implementation (hereinafter referred to as implementation #1), after UE #1 performs N (N>1) repeated transmissions of TB #1, one PSFCH feedback resource may be sent.

For example, in the process of sending (transmitting) the TB #1, the UE #1 may repeatedly send it N times. Herein, one transmission of TB #1 may correspond to one PSSCH resource. After the UE #1 transmits the PSSCH for the N-th time, that is, after the UE #1 sends the TB #1 for the N-th time, one PSFCH feedback resource may be transmitted.

In some embodiments, when selecting N PSSCH transmission resources for TB #1, UE #1 may select/determine time-frequency positions of the N PSSCH resources in one resource selection process, and may select a time-frequency position of a PSFCH resource corresponding to the N PSSCH resources. In other words, the time-frequency positions of the N PSSCH resources and the time-frequency position of the corresponding PSFCH resource may be determined by the UE #1 during one resource selection process.

In some embodiments, UE #2 may determine feedback information on a PSFCH resource according to the reception of the TB #1 on the N PSSCH resources. Exemplarily, assuming that UE #1 sends the TB #1 N times, if the UE #2 correctly receives the TB #1 at least once during the reception process of the TB #1, it may feed back a ACK in the PSFCH resource. If UE #2 fails to correctly receive the TB #1 even once during the reception process of the TB #1, it may feed back an NACK in the PSFCH resource.

Herein, the UE #2 correctly receives TB #1, which may also be understood as that UE #2 successfully decodes the TB #1 after receiving it.

In the implementation #1, if UE #1 receives an NACK fed back by the UE #2, the UE #1 may perform resource selection again, and select N′ (N′>1) retransmission resources for the TB #1. After the N′ retransmission resources, one PSFCH feedback resource may be provided.

In some scenarios, the values of N and N′ are both integers greater than 1, which can help terminals save power energy as much as possible. In other scenarios, since the initial transmission is critical to the transmission of TB, the value of N may be equal to 1. That is, the PSSCH resources for initial transmission of TB #1 may correspond to one PSFCH feedback resource, and the N′ PSSCH resources for retransmission of TB #1 may correspond to another one PSFCH feedback resource.

In the second implementation (hereinafter referred to as implementation #2), UE #1 may select/determine multiple sets of resources for transmission of TB #1. For example, when performing the resource selection, UE #1 may select/determine two sets of PSSCH resources in one resource selection process, where each set of PSSCH resources may correspond to one PSFCH feedback resource.

For example, it is assumed that the first set of transmission resources selected by UE #1 includes M1 PSSCH resources and one corresponding PSFCH resource, and the second set of transmission resources includes M2 PSSCH resources and one corresponding PSFCH resource. Then, in the process of sending (transmitting) the TB #1, the UE #1 may first perform M1 transmissions of TB #1 in the first set of transmissions, or UE #1 may perform the first set of transmissions of TB #1 on the M1 PSSCH resources, and the M1 transmissions may subsequently correspond to one PSFCH feedback. If UE #1 receives an NACK in the PSFCH feedback, the UE #1 may perform M2 transmissions of TB #1 in the second set of transmissions, or the UE #1 may perform the second set of transmissions of the TB #1 on the M2 PSSCH resources, and the M2 transmissions may subsequently correspond to one PSFCH feedback.

It may be understood that if the UE #1 receives a ACK on the PSFCH resource corresponding to the above M1 PSSCH resources, it indicates that the UE #2 has correctly received the TB #1. In this case, the UE #1 may not need to perform subsequent M2 transmissions of the TB #1.

In some embodiments, UE #2 may determine respective feedback information on each of the PSFCH resources according to the reception of the TB #1 on the two sets of PSSCH resources.

Exemplarily, for the M1 transmissions of TB #1, if UE #2 correctly receives and successfully decodes the TB #1 at least once during the reception process of the TB #1, it may feed back a ACK in a PSFCH resource corresponding to the M1 PSSCH resources. If UE #2 fails to correctly receive the TB #1 even once during the reception process of the TB #1, it may feed back an NACK in a PSFCH resource corresponding to the M1 PSSCH resources.

Similarly, for the M2 transmissions of TB #1, if UE #2 correctly receives and successfully decodes the TB #1 at least once during the reception process of the TB #1, it may feed back a ACK in a PSFCH resource corresponding to the M2 PSSCH resources. If UE #2 fails to receive and decode each transmission of the TB #1 during the reception process of the TB #1, it may feed back an NACK in a PSFCH resource corresponding to the M2 PSSCH resources.

In some scenarios, the values of M1 and M2 are both integers greater than 1, which can help terminals save power energy as much as possible. In other scenarios, since the initial transmission is critical to the sending of TB, the value of M1 may be equal to 1. That is, the PSSCH resources for initial transmission of TB #1 may correspond to one PSFCH feedback resource, and the M2 PSSCH resources for retransmission of TB #1 may correspond to another one PSFCH feedback resource.

It may be understood that the implementation #1 and implementation #2 differ in that: whether UE #1 needs to select/determine multiple sets of resources for transmission of TB #1 at a time. In the implementation #1, the UE #1 may determine whether the TB #1 needs to be retransmitted according to the feedback situation in the previous PSFCH, and if the retransmission is needed, the UE #1 may select/determine retransmission resources for the TB #1. That is, the UE #1 may determine whether to perform resource selection or reselection according to the received feedback information. In the implementation #2, the UE #1 may select/determine multiple sets of PSSCH resources for TB #1 transmission at a time. For example, the UE #1 may select (M1+M2) PSSCH resources at a time.

In some embodiments, the UE #1 may be, for example, a first-type terminal, and the UE #2 may be, for example, a second-type terminal.

The first-type terminal refers to terminals with full capability, or terminals with strong capability or terminals with high capability, such as mobile phones. The second-type terminal refers to weak-capability terminals, such as smart watches, bracelets, AR/VR glasses, etc. Generally, a bandwidth supported by the second-type terminals for sending/receiving information is relatively narrower. For example, the second-type terminals may support sending/receiving information on a sub-bandwidth but cannot support sending/receiving information across the full bandwidth. In addition, in some scenarios, transmit powers of the second-type terminals are also smaller, and their encoding/decoding capabilities may be limited.

According to the method of the embodiments, when UE #1 is a first-type terminal (weak-capability terminal) and UE #2 is a second-type terminal (stronger-capability terminal), the number of PSFCH transmissions is reduced for the weak-capability terminals, and thus power consumption is reduced. At the same time, for the strong-capability terminals, the number of times they retrieve/receive PSFCH is reduced, thereby achieving the purpose of saving power.

In some embodiments, UE #1 may be a second-type terminal, and UE #2 may be a first-type terminal. Alternatively, UE #1 and UE #2 may both be the first-type terminals, or UE #1 and UE #2 may both be the second-type terminals.

In order for understanding, FIGS. 17A-C illustrate examples of the above implementation #1.

As illustrated in FIGS. 17A-C, after four transmissions of TB #1, it may correspond to one PSFCH feedback resource. The UE receiving the PSSCHs may determine whether to feed back ACK or NACK in the PSFCH according to the reception/decoding of the four PSSCHs.

In FIG. 17A, the first and third transmissions of TB #1 are not correctly received, and the second and fourth transmissions of TB #1 are correctly received, that is, the TB #1 is correctly received/decoded twice. Thus, ACK is fed back.

For another example, in FIG. 17B, four transmissions of TB #1 are not correctly received/decoded, and thus NACK is fed back. In this case, the UE sending the PSSCHs (TB #1) needs to reselect PSSCH resources for retransmission of TB #1 after receiving the NACK information fed back through the PSFCH. For example, in FIG. 17B, the US sending the PSSCHs reselects two PSSCH resources for retransmission of TB #1.

For another example, in FIG. 17C, the first, third and fourth transmissions of TB #1 are not correctly received/decoded, and the second transmission of TB #1 is correctly received/decoded, that is, the TB #1 is correctly received/decoded once. Thus, ACK is fed back.

FIGS. 18A-B illustrate examples of the above implementation #2.

As illustrated in FIG. 18, for sending of one TB, every two PSSCH resources may correspond to one PSFCH feedback resource. A UE that sends PSSCHs needs to determine at least two sets of PSSCH resources and corresponding PSFCH resources for a to-be-transmitted TB.

In the examples of FIGS. 18A-B, the UE sending the PSSCHs determines two sets of PSSCH resources and corresponding PSFCH resources for TB #1 according to listening and resource selection. The first set of resources includes the first two PSSCH resources and a corresponding PSFCH resource, and the second set of resources includes the last two M2 PSSCH resources and a corresponding PSFCH resource.

As illustrated in FIG. 18A, the first two transmissions of TB #1 are not correctly received/decoded, and thus the receiving UE feeds back an NACK over the PSFCH resource. In this case, the sending UE continues to retransmit TB #1 on the second set of PSSCH resources (i.e. the last two PSSCH resources). As illustrated in FIG. 18A, one of the transmissions of TB #1 on the second set of PSSCH resources is successfully received/decoded, and thus ACK is fed back by PSFCH.

As illustrated in FIG. 18B, one of the first two transmissions of TB #1 is correctly received/decoded, and thus ACK is fed back by the PSFCH. In this case, the second set of PSSCH resources and the corresponding PSFCH feedback resource does not need to be used again.

### Scheme 2

In scheme 2, the DRX function may operate collaboratively with the SL feedback function, so that energy saving of terminals can be achieved based on the characteristics of the DRX function.

In some embodiments, when the UE #1 enables transmission/reception or when the UE #1 is in the DRX active state, UE #2 may send a PSFCH to UE #1.

Exemplarily, when UE #1 is in the DRX active state, the UE #1 may send PSSCHs to UE #2. Accordingly, UE #2 may feed back a PSFCH to the UE #1 when the UE #1 is in the DRX active state. In some embodiments, UE #2 needs to be in DRX active state when it receives PSSCHs. Accordingly, the UE #2 also needs to be in the DRX active state of the DRX when it sends the PSFCH.

In some embodiments, PSSCHs and the corresponding PSFCH may for example be transmitted in different DRX cycles. For example, only the PSSCHs may be transmitted in one DRX cycle, and a corresponding PSFCH may not be transmitted. The PSFCH may be fed back, for example, in a next DRX cycle for the DRX cycle.

Exemplarily, when UE #1 sends PSSCHs within one DRX active state cycle, if the slot resource in which the UE #2 feeds back the PSFCH is not within the active state DRX cycle, the UE #2 needs to wait until the next DRX active state to feed back the PSFCH to the UE #1.

FIG. 19 illustrates an example of the scheme 2. Herein, ON indicates that UE is in DRX active state, and OFF indicates that UE is in DRX inactive state. When there is a DRX in the system, both the transmission/reception of the PSSCHs and the transmission/reception of the corresponding PSFCH require that the UE is in the active state of the DRX. That is, when the UE is in the inactive state of DRX, it cannot transmit/receive any information.

As illustrated in FIG. 19, the sending resources of TB #1 (which is an example of the first transport block) and the corresponding PSFCH feedback resource are located in the active state of the same DRX cycle. That is, the occasion at which UE #1 sends TB #1 and the occasion at which UE #2 sends PSFCH are both located in the active state of the same DRX cycle.

As illustrated in FIG. 19, the first four sending resources of TB #2 (which is another example of the first transport block) and the corresponding PSFCH feedback resource are located in the same DRX cycles of active state. In this example, the first four transmissions of TB #2 are not correctly received/decoded, and thus NACK is fed back by PSFCH. The UE #1 performs selection of retransmission resources. Here, two retransmission resources and the first four transmission resources of TB #2 are still located in the active state of the same DRX cycle.

FIG. 20 illustrates another example of the scheme 3. Herein, ON indicates that UE is in DRX active state, and OFF indicates that UE is in DRX inactive state.

As illustrated in FIG. 20, when the four transmissions of TB #1 are completed, the DRX active state of the UE #1 is about to end, or it is about to enter the OFF state. At this time, UE #2 needs to wait until the next DRX activation state (that is, the active state of the next DRX cycle) before performing PSFCH feedback.

In the example of FIG. 20, since ACK is fed back by the PSFCH, the TB #1 does not need to be retransmitted. It may be understood that if the first four PSSCH reception/decoding of TB #1 fails and an NACK is fed back in the PSFCH, the UE #1 needs to perform resource selection again to select resources for retransmission of TB #1. In the example of FIG. 20, the retransmission resources are also located within the active state of the next DRX cycle, or the PSFCH resource and the retransmission resources are located in the active state of the same DRX cycle.

### Scheme 3

In scheme 3, the COT duration may operate collaboratively with DRX function. This scheme solves the problem of how to use the COT in scenarios where SL is enabled in the unlicensed frequency band with DRX function activated and the COT duration overlaps with the DRX ON/OFF boundaries.

Exemplarily, when a duration of the DRX active state overlaps with the COT duration of a UE (e.g., UE #1 or UE #2), the duration of the DRX active state will be used.

As an example, assuming that the DRX activation state ends at moment n and the COT duration ends at moment n+i (i>0), then the slot resources within [n, n+i] of the COT are considered to be no longer used. That is, the UE will not use the slot resources within [n, n+i] of the COT for transmission/reception. In other words, if the COT duration and the duration of the DRX activation state of the UE overlap partially, the slot resources, corresponding to the overlapping portion, within the COT may be used by the UE, while the slot resources corresponding to the non-overlapping portion, within the COT will not be used by the UE.

As another example, assuming that the DRX activation state starts at moment m and ends at moment n, and assuming that the COT duration starts at moment m+i (i>0) and ends at moment n−i, then all of the slot resources within the COT may be used by the UE. In other words, if the COT duration of the UE is contained in the time period for which the DRX active state lasts, all slot resources within the COT may be used by the UE.

This scheme defines the behavior of how to use the COT when it overlaps with DRX, which reduces resource waste and avoids invalid transmission, thereby improving the resource utilization.

FIG. 21 illustrates an example of the scheme 3. Herein, ON indicates that UE is in DRX active state, and OFF indicates that UE is in DRX inactive state. When both DRX and COT are present in the system, if the COT duration overlaps with the ON and OFF of the DRX, then it needs to determine whether the remaining duration of the COT is available based on the DRX.

For example, COT1 becomes unavailable after time t because the DRX enters an inactive state, and the terminal cannot transmit/receive any information. For another example, the duration of COT2 is located within one ON time duration of DRX, so COT2 may be fully used.

### Scheme 4

In the scheme 4, the maximum number of transmissions of one TB (such as TB #1) may be reduced to L, so as to reduce the power consumption of the terminal. Here, the maximum number of transmissions may include, for example, the total number of initial transmissions and retransmissions.

Exemplarily, the value of the maximum number L of the transmissions of one TB may be less than 32 in prior art. For example, the value of L may be 4, 6, 8, 16 etc., or the value of L may be any integer from 1 to 16. Here, the value of L may be determined, for example, through configuration/pre-configuration.

The embodiment of the present disclosure provides a design solution for sidelink feedback resources and flows, so as to achieve the purpose of energy saving of terminals. On one hand, in the solution, one PSFCH may be fed back after multiple PSSCH transmissions, to avoid frequent transmission/reception of PSFCH for terminals (e.g., weak-capability terminals), thereby achieving energy saving of the terminals. On the other hand, when there is a DRX mechanism in the system, this solution combines data transmission resources, feedback resources, COT and other mechanisms, thereby improving the resource utilization and avoiding resource waste.

The preferred embodiments of the present disclosure have been described in detail above with reference to the accompanying drawings, but the present disclosure is not limited to the specific details in the above-described embodiments. Various simple modifications may be made to the technical solutions of the present disclosure within the scope of the technical concept of the present disclosure, and these simple modifications all fall within the scope of protection of the present disclosure. For example, various specific technical features described in the above-described detailed description may be combined in any suitable manner without contradiction, and various possible combinations will not be described separately in this application in order to avoid unnecessary repetition. For another example, various embodiments of the present disclosure may be combined arbitrarily, and as long as they do not violate the idea of the present disclosure, they should also be regarded as the disclosure of the present disclosure. For another example, on the premise that there is no conflict, various embodiments described in the present disclosure and/or the technical features in each embodiment may be arbitrarily combined with the prior art, and the technical solution obtained after the combination should also fall within the scope of protection of the present disclosure.

It should also be understood that in various method embodiments of the present disclosure, the size of the sequence number of the above-described processes does not mean an order of execution, and the order of execution of various processes should be determined by their functions and internal logics, and should not constitute any limitation on the implementation of the embodiments of the present disclosure. In addition, in the embodiments of the present disclosure, the terms “downlink”, “uplink”, and “sidelink” are used to indicate the transmission direction of signals or data, where “downlink” is used to indicate that the transmission direction of signals or data is a first direction transmitted from a site to user equipment of a cell, “uplink” is used to indicate that the transmission direction of signals or data is a second direction transmitted from the user equipment of the cell to the site, and “sidelink” is used to indicate that the transmission direction of signals or data is a third direction transmitted from the user equipment 1 to the user equipment 2. For example, “downlink signal” indicates that the transmission direction of the signal is the first direction. In addition, in the embodiments of the present disclosure, the term “and/or” is only one kind of association relationship that describes associated objects, and indicates that there may be three kinds of relationships. Specifically, A and/or B may represent the following three situations: i.e., independent existence of A, existence of both A and B and independent existence of B. In addition, the character “/” in the present disclosure generally represents that an “or” relationship is formed between the previous and next associated objects.

Based on the foregoing embodiments, corresponding apparatuses for sidelink feedback information transmission are provided by embodiments of the present disclosure.

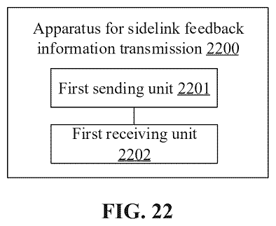

FIG. 22 is a first schematic diagram of an apparatus for sidelink feedback information transmission provided by an embodiment of the present disclosure. The apparatus is applied to a first terminal. As illustrated in FIG. 22, the apparatus for sidelink feedback information transmission 2200 includes a first sending unit 2201 and a first receiving unit 2202.

The first sending unit 2201 is configured to send a first transport block to a second terminal on a plurality of first PSSCH resources. The first receiving unit is configured to receive first feedback information from the second terminal on a first PSFCH resource, the first feedback information being feedback for reception of the first transport block by the second terminal on the plurality of first PSSCH resources.

In some embodiments, if the second terminal correctly receives the first transport block on at least one first PSSCH resource of the plurality of first PSSCH resources, the first feedback information indicates that the second terminal has correctly received the first transport block. If the second terminal does not correctly receive the first transport block on the plurality of first PSSCH resources, then the first feedback information indicates that the second terminal has correctly received the first transport block.

In some embodiments, in a case where the first feedback information indicates that the second terminal has correctly received the first transport block, the first feedback information includes ACK. In a case where the first feedback information indicates that the second terminal has not correctly received the first transport block, the first feedback information includes NACK.

In some embodiments, time-frequency positions of the plurality of first PSSCH resources and the first PSFCH resource are determined by the apparatus 2200 during one resource selection process.

In some embodiments, the apparatus 2200 further includes a second sending unit and a second receiving unit. The second sending unit is configured to send the first transport block to the second terminal on a plurality of second PSSCH resources in a case where the first feedback information indicates that the second terminal has not correctly received the first transport block. The second receiving unit is configured to receive second feedback information from the second terminal on a second PSFCH resource, where the second feedback information is feedback for the reception of the first transport block by the second terminal on the plurality of second PSSCH resources.

In some embodiments, if the second terminal correctly receives the first transport block on at least one second PSSCH resource of the plurality of second PSSCH resources, the second feedback information indicates that the second terminal has correctly received the first transport block. If the second terminal does not correctly receive the first transport block on the plurality of first PSSCH resources, then the second feedback information indicates that the second terminal has not correctly received the first transport block.

In some embodiments, in a case where the second feedback information indicates that the second terminal has correctly received the first transport block, the second feedback information includes ACK. In a case where the second feedback information indicates that the second terminal has not correctly received the first transport block, the second feedback information includes NACK.

In some embodiments, time-frequency positions of the plurality of first PSSCH resources, the first PSFCH resource, the plurality of second PSSCH resources and the second PSFCH resource are determined by the apparatus 2200 during one resource selection process. Alternatively, the plurality of second PSSCH resources and the second PSFCH resource are determined by the apparatus 2200 in a case where the first feedback information indicates that the second terminal has not correctly received the first transport block.

In some embodiments, when the apparatus 2200 sends the first transport block and when the apparatus 2200 receives the first feedback information, the apparatus 2200 and the second terminal are in a DRX active state.

In some embodiments, when the apparatus 2200 sends the first transport block and when the apparatus 2200 receives the first feedback information and the second feedback information, the apparatus 2200 and the second terminal are in a DRX active state.

In some embodiments, the plurality of first PSSCH resources and the first PSFCH resource are located within an active state of a same DRX cycle; or the plurality of first PSSCH resources and the first PSFCH resource are located within active states of different DRX cycles.

In some embodiments, the plurality of PSSFCH resources are located within the active state of the first DRX cycle. If a time interval between an ending time of a last first PSSCH resource of the plurality of first PSSCH resources and an ending time of an active state of the first DRX cycle is less than a first threshold, then the first PSFCH resource is located within an active state of a next DRX cycle for the first DRX cycle.

In some embodiments, the first threshold is a time domain length of the first PSFCH resource.

In some embodiments, if channel occupancy time (COT) of the apparatus 2200 is contained in a time duration of the DRX active state, then the apparatus 2200 is capable of communicating with the second terminal within the COT. If the COT of the apparatus 2200 partially overlaps with the time duration of the DRX active state, then the apparatus 2200 is capable of communicating with the second terminal within a portion of the COT that overlaps.

In some embodiments, the maximum number of transmissions of the first transport block is less than 32.

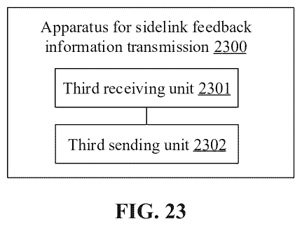

FIG. 23 is a second schematic diagram of an apparatus for sidelink feedback information transmission provided by an embodiment of the present disclosure. The apparatus is applied to a second terminal. As illustrated in FIG. 23, the apparatus for sidelink feedback information transmission 2300 includes a third receiving unit 2301 and a third sending unit 2302.

The third receiving unit 2301 is configured to receive a first transport block from a first terminal on a plurality of first PSSCH resources. The third sending unit 2302 is configured to send first feedback information to the first terminal on a first PSFCH resource, the first feedback information being feedback for reception of the first transport block by the apparatus 2300 on the plurality of first PSSCH resources.

In some embodiments, if the apparatus 2300 correctly receives the first transport block on at least one first PSSCH resource of the plurality of first PSSCH resources, the first feedback information indicates that the apparatus 2300 has correctly received the first transport block. If the apparatus 2300 does not correctly receive the first transport block on the plurality of first PSSCH resources, then the first feedback information indicates that the apparatus 2300 has not correctly received the first transport block.

In some embodiments, in a case where the first feedback information indicates that the apparatus 2300 has correctly received the first transport block, the first feedback information includes ACK. In a case where the first feedback information indicates that the apparatus 2300 has not correctly received the first transport block, the first feedback information includes NACK.

In some embodiments, time-frequency positions of the plurality of first PSSCH resources and the first PSFCH resource are determined by the first terminal during one resource selection process.

In some embodiments, the apparatus 2300 further includes a fourth receiving unit and a fourth sending unit. The fourth receiving unit is configured to receive the first transport block from the first terminal on a plurality of second PSSCH resources in a case where the first feedback information indicates that the apparatus 2300 has not correctly received the first transport block. The fourth sending unit is configured to send second feedback information to the first terminal on a second PSFCH resource, where the second feedback information is feedback for the reception of the first transport block by the apparatus 2300 on the plurality of second PSSCH resources.

In some embodiments, if the apparatus 2300 correctly receives the first transport block on at least one second PSSCH resource of the plurality of second PSSCH resources, the second feedback information indicates that the apparatus 2300 has correctly received the first transport block. If the apparatus 2300 does not correctly receive the first transport block on each of the plurality of second PSSCH resources, then the second feedback information indicates that the apparatus 2300 has not correctly received the first transport block.

In some embodiments, in a case where the second feedback information indicates that the apparatus 2300 has correctly received the first transport block, the second feedback information includes ACK. In a case where the second feedback information indicates that the apparatus 2300 has not correctly received the first transport block, the second feedback information includes NACK.

In some embodiments, time-frequency positions of the plurality of first PSSCH resources, the first PSFCH resource, the plurality of second PSSCH resources and the second PSFCH resource are determined by the first terminal during one resource selection process; or the plurality of second PSSCH resources and the second PSFCH resource are determined by the first terminal in a case where the first feedback information indicates that the apparatus 2300 has not correctly received the first transport block.

In some embodiments, when the apparatus 2300 receives the first transport block and when the apparatus 2300 sends the first feedback information, the first terminal and the apparatus 2300 are in a DRX active state.

In some embodiments, when the apparatus 2300 receives the first transport block and when the apparatus 2300 sends the first feedback information and the second feedback information, the second terminal and the apparatus 2300 are in a DRX active state.

In some embodiments, the plurality of first PSSCH resources and the first PSFCH resource are located within an active state of the same DRX cycle; or the plurality of first PSSCH resources and the first PSFCH resource are located within active states of different DRX cycles.

In some embodiments, the plurality of PSSFCH resources are located within the active state of the first DRX cycle. If a time interval between an ending time of a last first PSSCH resource of the plurality of first PSSCH resources and an ending time of an active state of the first DRX cycle is less than a first threshold, then the first PSFCH resource is located within an active state of a next DRX cycle for the first DRX cycle.

In some embodiments, the first threshold is a time domain length of the first PSFCH resource.

In some embodiments, if COT of the apparatus 2300 is contained in a time duration of the DRX active state, then the apparatus 2300 is capable of communicating with the second terminal within the COT. If the COT of the apparatus 2300 partially overlaps with the time duration of the DRX active state, then the apparatus 2300 is capable of communicating with the second terminal within a portion of the COT that overlaps.

In some embodiments, the maximum number of transmissions of the first transport block is less than 32.

Those skilled in the art should understand that the related description of the sidelink feedback information transmission apparatuses according to the embodiments of the present disclosure may be understood with reference to the related description of the sidelink feedback information transmission methods according to the embodiments of the present disclosure.

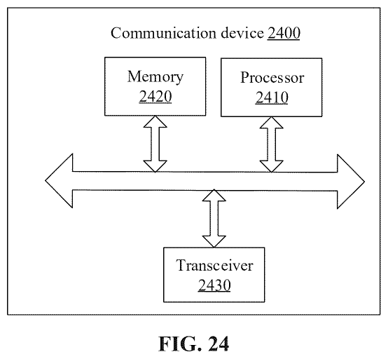

FIG. 24 is a schematic structure diagram of a communication device 2400 provided by an embodiment of the present disclosure. The communication device 2400 illustrated in FIG. 24 includes a processor 2410 that may call and execute a computer program from a memory to implement the methods in the embodiments of the present disclosure.

Optionally, as illustrated in FIG. 24, the communication device 2400 may further include a memory 2420. The processor 2410 may call and execute a computer program from the memory 2420 to implement the methods in the embodiments of the present disclosure.

The memory 2420 may be a separate device independent of the processor 2410, or may be integrated in the processor 2410.

Optionally, as illustrated in FIG. 24, the communication device 2400 may include a transceiver 2430. The processor 2410 may control the transceiver 2430 to communicate with other devices, and specifically, may send information or data to other devices or receive information or data sent from other devices.

Here, the transceiver 2430 may include a transmitter and a receiver. The transceiver 2430 may further include antennas, and the number of antennas may be one or more.

Optionally, the communication device 2400 may be the first terminal of the embodiments of the present disclosure, and the communication device 2400 may implement corresponding processes implemented by the first terminal in various methods of the embodiments of the present disclosure, which will not be repeated here for the sake of brevity.

Optionally, the communication device 2400 may be the second terminal in the embodiments of the present disclosure, and the communication device 2400 may implement the corresponding process implemented by the second terminal in various methods of the embodiments of the present disclosure, which will not be repeated here for the sake of brevity.

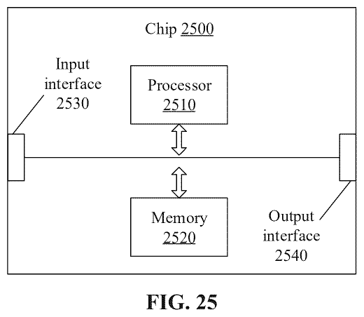

FIG. 25 is a schematic structure diagram of a chip provided by an embodiment of the present disclosure. The chip 2500 illustrated in FIG. 25 includes a processor 2510 that may call and execute a computer program from a memory to implement the methods in the embodiments of the present disclosure.

Optionally, as illustrated in FIG. 25, the chip 2500 may further include a memory 2520. The processor 2510 may call and execute a computer program from the memory 2520 to implement the methods in the embodiments of the present disclosure.

The memory 2520 may be a separate device independent of the processor 2510, or may be integrated in the processor 2510.

Optionally, as illustrated in FIG. 25, the chip 2500 may further include an input interface 2530. The processor 2510 may control the input interface 2530 to communicate with other devices or chips, and specifically, may acquire information or data transmitted by other devices or chips.

Optionally, the chip 2500 may further include an output interface 2540. The processor 2510 may control the output interface 2540 to communicate with other devices or chips, and specifically, may output information or data to other devices or chips.

The chip may be applied to the first terminal of the embodiments of the present disclosure, and the chip may implement corresponding processes implemented by the first terminal in various methods of the embodiments of the present disclosure, which will not be repeated here for the sake of brevity.

Optionally, the chip may be applied to the second terminal in the embodiments of the present disclosure, and the chip may implement the corresponding process implemented by the second terminal in various methods of the embodiments of the present disclosure, which will not be repeated here for the sake of brevity.

It is to be understood that the chip mentioned in the embodiments of the present disclosure may also be referred to as a system-level chip, a system chip, a chip system or a system-on-chip or the like.

It is to be understood that the processor of the present disclosure may be an integrated circuit chip having a signal processing capability. In implementation, the actions of the above method embodiments may be accomplished by integrated logic circuitry of hardware in the processor or instructions in the form of software. The above processor may be a general purpose processor, a digital signal processor (DSP), an application specific integrated circuit (ASIC), a field programmable gate array (FPGA) or other programmable logic devices, discrete gates or transistor logic devices, or discrete hardware components. The processor may implement or execute the methods, actions and logic diagrams disclosed in the embodiments of the present disclosure. The general purpose processor may be a microprocessor or any conventional processor. The actions of the method disclosed in the embodiments of the present disclosure may be directly embodied as being executed by a hardware decoding processor or being executed by hardware and software modules in a decoding processor. The software modules may be located in a storage medium mature in the art, such as a random access memory, a flash memory, a read-only memory, a programmable read-only memory or an electrically erasable programmable memory, a register, etc. The storage medium is located in the memory, and the processor reads the information in the memory to complete the actions of the aforementioned method in conjunction with its hardware.

It will be appreciated that the memory in the embodiments of the present disclosure may be a volatile memory or a non-volatile memory, or may also include both a volatile memory and a non-volatile memory. The non-volatile memory may be a read-only memory (ROM), a programmable ROM (PROM), an erasable PROM (EPROM), an electrically EPROM (EPROM) or a flash memory. The volatile memory may be a random access memory (RAM), which serves as an external cache. By way of illustration but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM). It is to be noted that the memory in the systems and methods described herein is intended to include, but is not limited to, these memories and any other suitable types of memory.

It is to be understood that the memory described above is exemplary but not limiting. For example, the memory in the embodiments of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM), etc. That is, the memory in the embodiments of the present disclosure is intended to include, but is not limited to, these memories and any other suitable types of memory.

In an embodiment of the present disclosure, there is further provided a computer-readable storage medium for storing a computer program.

Optionally, the computer readable storage medium may be applied to the first terminal of the embodiments of the present disclosure, and the computer program causes a computer to implement corresponding processes implemented by the first terminal in the methods of the embodiments of the present disclosure, which will not be repeated here for the sake of brevity.

Optionally, the computer readable storage medium may be applied to the second terminal of the embodiments of the present disclosure, and the computer program causes a computer to implement corresponding processes implemented by the first terminal in the methods of the embodiments of the present disclosure, which will not be repeated here for the sake of brevity.

In an embodiment of the present disclosure, there is further provided a computer program product, which includes computer program instructions.

Optionally, the computer program product may be applied to the first terminal of the embodiments of the present disclosure, and the computer program instructions cause a computer to implement corresponding processes implemented by the first terminal in the methods of the embodiments of the present disclosure, which will not be repeated here for the sake of brevity.

Optionally, the computer program product may be applied to the second computer program instructions cause a computer to implement corresponding processes implemented by the second terminal in the methods of the embodiments of the present disclosure, which will not be repeated here for the sake of brevity.

In an embodiment of the present disclosure, there is further provided a computer program.

Optionally, the computer program may be applied to the first terminal in the embodiments of the present disclosure, and when the computer program is running on the computer, the computer executes the corresponding process implemented by the first terminal in each method of the embodiments of the present disclosure, which is not repeated here for the sake of brevity.

Optionally, the computer program may be applied to the second terminal in the embodiment of the present disclosure, and when the computer program is running on the computer, the computer executes the corresponding process implemented by the second terminal in each method of the embodiment of the present disclosure, which is not repeated here for the sake of brevity.

Those of ordinary skill in the art may realize that the various example units and algorithm steps described in connection with the embodiments disclosed herein may be implemented in electronic hardware or a combination of computer software and electronic hardware. Whether these functions are performed in hardware or software depends on the specific application and design constraints of the technical solution. Professionals may use different methods for each particular application to implement the described functionality, but such implementation should not be considered beyond the scope of the present disclosure.

Those skilled in the art will clearly appreciate that, for convenience and conciseness of description, the specific operating processes of the above-described systems, apparatuses and units may refer to the corresponding processes in the aforementioned method embodiments and will not be repeated herein.

In several embodiments provided herein, it is to be understood that the disclosed systems, apparatuses and methods may be implemented in other manners. For example, the above-described embodiments of the apparatus are only schematic, for example, the division of the units is only a logical function division, and in practice, there may be another division manner, for example, multiple units or components may be combined or integrated into another system, or some features may be ignored or not performed. In addition, the coupling or direct coupling or communication connection between each other illustrated or discussed may be indirect coupling or communication connection through some interfaces, devices or units, and may be electrical, mechanical or other form.

The units illustrated as separate elements may or may not be physically separated, and the elements displayed as units may or may not be physical units, i.e. may be located in a place, or may be distributed over a plurality of network units. Part or all of the units may be selected according to the actual needs to achieve the purpose of the embodiments of the present disclosure.

In addition, various functional unit in various embodiments of the present disclosure may be integrated in one processing unit, each unit may exist physically alone, or two or more units may be integrated in one unit.

When the functions are realized in the form of software functional units and sold or used as an independent product, they may be stored in a computer readable storage medium. Based on such an understanding, the technical solutions according to the disclosure, in essence or the part contributing to the prior art, or part of the technical solutions may be embodied in the form of a software product. The computer software product is stored in a storage medium, and includes several instructions so that a computer device (which may be a personal computer, a server, a network device or the like) implements all or part of the method according to respective embodiments of the disclosure. The aforementioned storage medium includes various media capable of storing a program code such as a USB disk, a mobile hard drive disk, a read-only memory (ROM), a random access memory (RAM), a magnetic disk or an optical disk.

The above is only the specific implementation of the present disclosure, but the scope of protection of the present disclosure is not limited thereto. Any person skilled in the art may easily think of changes or substitutions within the technical scope disclosed in the present disclosure, which is to be covered within the protection scope of the present disclosure. Therefore, the scope of protection of the present disclosure shall be subject to the scope of protection of the claims.

1. A method for sidelink feedback information transmission, applied to a first terminal, the method comprising:
sending a first transport block to a second terminal on a plurality of first physical sidelink shared channel (PSSCH) resources; and
receiving first feedback information from the second terminal on a first physical sidelink feedback channel (PSFCH) resource, the first feedback information being feedback for reception of the first transport block by the second terminal on the plurality of first PSSCH resources.

2. The method of claim 1, wherein
if the second terminal correctly receives the first transport block on at least one first PSSCH resource of the plurality of first PSSCH resources, the first feedback information indicates that the second terminal has correctly received the first transport block; and
if the second terminal does not correctly receive the first transport block on the plurality of first PSSCH resources, the first feedback information indicates that the second terminal has not correctly received the first transport block,
wherein in a case where the first feedback information indicates that the second terminal has correctly received the first transport block, the first feedback information comprises an acknowledgement (ACK); and
in a case where the first feedback information indicates that the second terminal has not correctly received the first transport block, the first feedback information comprises a negative acknowledgement (NACK).

3. The method of claim 1, wherein
time-frequency positions of the plurality of first PSSCH resources and the first PSFCH resource are determined by the first terminal during one resource selection process.

4. The method of claim 1, wherein in a case where the first feedback information indicates that the second terminal has not correctly received the first transport block, the method further comprises:
sending the first transport block to the second terminal on a plurality of second PSSCH resources; and
receiving second feedback information from the second terminal on a second PSFCH resource, the second feedback information being feedback for reception of the first transport block by the second terminal on the plurality of second PSSCH resources,
wherein if the second terminal correctly receives the first transport block on at least one second PSSCH resource of the plurality of second PSSCH resources, the second feedback information indicates that the second terminal has correctly received the first transport block; and
if the second terminal does not correctly receive the first transport block on the plurality of second PSSCH resources, the second feedback information indicates that the second terminal has not correctly received the first transport block,
wherein in a case where the second feedback information indicates that the second terminal has correctly received the first transport block, the second feedback information comprises an acknowledgement (ACK); and
in a case where the second feedback information indicates that the second terminal has not correctly received the first transport block, the second feedback information comprises a negative acknowledgement (NACK).

5. The method of claim 4, wherein
time-frequency positions of the plurality of first PSSCH resources, the first PSFCH resource, the plurality of second PSSCH resources and the second PSFCH resource are determined by the first terminal during one resource selection process; or
time-frequency positions of the plurality of second PSSCH resources and the second PSFCH resource are determined by the first terminal in a case where the first feedback information indicates that the second terminal has not correctly received the first transport block.

6. The method of claim 1, wherein
when the first terminal sends the first transport block and when the first terminal receives the first feedback information, the first terminal and the second terminal are in a discontinuous reception (DRX) active state.

7. The method of claim 4, wherein
when the first terminal sends the first transport block and when the first terminal receives the first feedback information and the second feedback information, the first terminal and the second terminal are in a DRX active state.

8. The method of claim 1, wherein
if channel occupancy time of the first terminal is contained within a time duration of a DRX active state, the first terminal is capable of communicating with the second terminal during the channel occupancy time; and
if the channel occupancy time of the first terminal partially overlaps with the time duration of the DRX active state, the first terminal is capable of communicating with the second terminal within a portion of the channel occupancy time that overlaps.

9. A first terminal, comprising:
a processor, and a memory for storing a computer program, wherein the processor is configured to invoke and execute the computer program stored in the memory to cause the first terminal to:
send a first transport block to a second terminal on a plurality of first physical sidelink shared channel (PSSCH) resources; and
receive first feedback information from the second terminal on a first physical sidelink feedback channel (PSFCH) resource, the first feedback information being feedback for reception of the first transport block by the second terminal on the plurality of first PSSCH resources.

10. The first terminal of claim 9, wherein
if the second terminal correctly receives the first transport block on at least one first PSSCH resource of the plurality of first PSSCH resources, the first feedback information indicates that the second terminal has correctly received the first transport block; and
if the second terminal does not correctly receive the first transport block on the plurality of first PSSCH resources, the first feedback information indicates that the second terminal has not correctly received the first transport block,
wherein in a case where the first feedback information indicates that the second terminal has correctly received the first transport block, the first feedback information comprises an acknowledgement (ACK); and
in a case where the first feedback information indicates that the second terminal has not correctly received the first transport block, the first feedback information comprises a negative acknowledgement (NACK).

11. The first terminal of claim 9, wherein
time-frequency positions of the plurality of first PSSCH resources and the first PSFCH resource are determined by the first terminal during one resource selection process.

12. The first terminal of claim 9, wherein the processor is further configured to invoke and execute the computer program stored in the memory to cause the first terminal to:
send the first transport block to the second terminal on a plurality of second PSSCH resources in a case where the first feedback information indicates that the second terminal has not correctly received the first transport block; and
receive second feedback information from the second terminal on a second PSFCH resource, the second feedback information being feedback for reception of the first transport block by the second terminal on the plurality of second PSSCH resources,
wherein if the second terminal correctly receives the first transport block on at least one second PSSCH resource of the plurality of second PSSCH resources, the second feedback information indicates that the second terminal has correctly received the first transport block; and
if the second terminal does not correctly receive the first transport block on the plurality of second PSSCH resources, the second feedback information indicates that the second terminal has not correctly received the first transport block,
wherein in a case where the second feedback information indicates that the second terminal has correctly received the first transport block, the second feedback information comprises an acknowledgement (ACK); and
in a case where the second feedback information indicates that the second terminal has not correctly received the first transport block, the second feedback information comprises a negative acknowledgement (NACK).

13. The first terminal of claim 9, wherein
the plurality of first PSSCH resources and the first PSFCH resource are located within an active state of a same DRX cycle; or
the plurality of first PSSCH resources and the first PSFCH resource are located within activate states of different DRX cycles.

14. The first terminal of claim 9, wherein
if channel occupancy time of the first terminal is contained within a time duration of a DRX active state, the first terminal is capable of communicating with the second terminal during the channel occupancy time; and
if the channel occupancy time of the first terminal partially overlaps with the time duration of the DRX active state, the first terminal is capable of communicating with the second terminal within a portion of the channel occupancy time that overlaps.

15. A second terminal, comprising:
a processor, and a memory for storing a computer program, wherein the processor is configured to invoke and execute the computer program stored in the memory to cause the second terminal to:
receive a first transport block from a first terminal on a plurality of first physical sidelink shared channel (PSSCH) resources; and
send first feedback information to the first terminal on a first physical sidelink feedback channel (PSFCH) resource, the first feedback information indicating feedback for reception of the first transport block by the second terminal on the plurality of first PSSCH resources.

16. The second terminal of claim 15, wherein
if the second terminal correctly receives the first transport block on at least one first PSSCH resource of the plurality of first PSSCH resources, the first feedback information indicates that the second terminal has correctly received the first transport block; and
if the second terminal does not correctly receive the first transport block on the plurality of first PSSCH resources, the first feedback information indicates that the second terminal has not correctly received the first transport block,
wherein in a case where the first feedback information indicates that the second terminal has correctly received the first transport block, the first feedback information comprises an acknowledgement (ACK); and
in a case where the first feedback information indicates that the second terminal has not correctly received the first transport block, the first feedback information comprises a negative acknowledgement (NACK).

17. The second terminal of claim 15, wherein
time-frequency positions of the plurality of first PSSCH resources and the first PSFCH resource are determined by the first terminal during one resource selection process.

18. The second terminal of claim 15, wherein the processor is further configured to invoke and execute the computer program stored in the memory to cause the second terminal to:
receive the first transport block from the first terminal on a plurality of second PSSCH resources in a case where the first feedback information indicates that the second terminal has not correctly received the first transport block; and
send second feedback information to the first terminal on a second PSFCH resource, the second feedback information being feedback for reception of the first transport block by the second terminal on the plurality of second PSSCH resources,
wherein if the second terminal correctly receives the first transport block on at least one second PSSCH resource of the plurality of second PSSCH resources, the second feedback information indicates that the second terminal has correctly received the first transport block; and
if the second terminal does not correctly receive the first transport block on the plurality of second PSSCH resources, the second feedback information indicates that the second terminal has not correctly received the first transport block,
wherein in a case where the second feedback information indicates that the second terminal has correctly received the first transport block, the second feedback information comprises an acknowledgement (ACK); and
in a case where the second feedback information indicates that the second terminal has not correctly received the first transport block, the second feedback information comprises a negative acknowledgement (NACK).

19. The second terminal of claim 18, wherein
when the second terminal receives the first transport block and when the second terminal sends the first feedback information, the first terminal and the second terminal are in a discontinuous reception (DRX) active state.

20. The second terminal of claim 18, wherein
when the second terminal receives the first transport block and when the second terminal sends the first feedback information and the second feedback information, the first terminal and the second terminal are in a DRX active state.
